(19) United States
(12) Patent Application Publication
(10) Pub. No.: US 2026/0107103 A1
(43) Pub. Date: Apr. 16, 2026

(54) HOME THEATRE AUDIO PLAYBACK WITH MULTICHANNEL SATELLITE PLAYBACK DEVICES

(71) Applicant: Sonos, Inc., Goleta, CA (US)

(72) Inventors: Paul Peace, Boston, MA (US); Roberto Maria Dizon, Cambridge, MA (US)

(21) Appl. No.: 19/116,972

(22) PCT Filed: Sep. 26, 2023
(86) PCT No.: PCT/US2023/075105

§ 371 Date: Mar. 28, 2025

Related U.S. Application Data
(60) Provisional application No. 63/377,895, filed on Sep. 30, 2022.
(60) Provisional application No. 63/377,897, filed on Sep. 30, 2022.
(60) Provisional application No. 63/377,901, filed on Sep. 30, 2022.
(60) Provisional application No. 63/377,905, filed on Sep. 30, 2022.
(60) Provisional application No. 63/483,469, filed on Feb. 6, 2023.

(51) Int. Cl. H04S 3/00; H04R 5/02

(52) U.S. Cl. CPC H04S 3/008; H04R 5/02; H04R 2420/07; H04S 2400/01; H04S 2400/03

(57) ABSTRACT

Home theatre audio configurations can include a primary audio playback device (e.g., a soundbar) along with a plurality of discrete satellite playback devices (e.g., left and right surrounds), some or all of which may be capable of multichannel audio playback. Techniques for modifying audio transmission, distribution, and/or playback for such multichannel satellite playback devices are disclosed.

### CROSS-REFERENCE TO RELATED APPLICATIONS

This application claims the benefit of priority to U.S. patent application Ser. No. 63/377,895, filed Sep. 30, 2022, to U.S. Patent Application No. 63/377,897, filed Sep. 30, 2022, to U.S. Patent Application No. 63/377,901, filed Sep. 30, 2022, to U.S. Patent Application No. 63/377,905, filed Sep. 30, 2022, and to U.S. Patent Application No. 63/483,469, filed Feb. 6, 2023, each of which is incorporated herein by reference in its entirety.

### FIELD OF THE DISCLOSURE

The present disclosure is related to consumer goods and, more particularly, to methods, systems, products, features, services, and other elements directed to media play back or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media play back systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, examples, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media play back system configured in accordance with examples of the present technology.

FIG. 1B is a schematic diagram of the media play back system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIG. 2A is a front isometric view of a playback device configured in accordance with examples of the present technology.

FIG. 2B is a front isometric view of the playback device of FIG. 3A without a grille.

FIG. 2C is an exploded view of the playback device of FIG. 2A.

FIG. 3A is a perspective view of a playback device configured in accordance with examples of the present technology.

FIG. 3B is a transparent view of the playback device of FIG. 3A illustrating individual transducers.

FIGS. 4A, 4B, 4C, and 4D are diagrams showing an example playback device configuration in accordance with examples of the present technology.

FIG. 5 is a schematic block diagram of a system for distributing audio data to multichannel satellite playback devices in accordance with examples of the present technology.

FIG. 6 is a flow diagram of a method for distributing audio data to multichannel satellite playback devices in accordance with examples of the present technology.

FIG. 7 is a schematic diagram of a system for distributing audio data to multichannel satellite playback devices in accordance with examples of the present technology.

FIG. 8 illustrates a distribution of audio channel among data channels for transmitting audio data to multichannel satellite playback devices in accordance with examples of the present technology.

FIG. 9 illustrates a home theatre environment including a primary playback device and a plurality of satellite playback devices in accordance with examples of the present technology.

FIGS. 10 and 11 are flow diagrams of methods for determining and adjusting play back device parameters in accordance with examples of the present technology.

FIGS. 12A and 12B illustrate a home theatre environment including a primary playback device and a plurality of front satellite playback devices in accordance with examples of the present technology.

FIG. 13 illustrates a control device user interface for modifying a width parameter of audio playback in accordance with examples of the present technology.

FIGS. 14A and 14B illustrate a home theatre environment including a primary playback device and a plurality of rear satellite playback devices in accordance with examples of the present technology.

FIG. 15 is a flow diagram of a method for modifying a width parameter of audio play back in accordance with examples of the present technology.

FIGS. 16A-16C illustrate a home theatre environment including a primary playback device and a plurality of satellite playback devices in accordance with examples of the present technology.

FIG. 17 is a flow diagram of a method for modifying playback parameters to compensate for satellite playback device placement in accordance with examples of the present technology.

FIG. 18 is a schematic illustration of audio playback in accordance with examples of the disclosed technology.

FIGS. 19A and 19B are graphs illustrating audio output contributions from various transducers in accordance with examples of the disclosed technology.

FIGS. 20A and 20B are graphs illustrating directivity of audio output as measured along different sound axes in accordance with examples of the disclosed technology.

FIGS. 21 and 22 are flow diagrams of methods for playing back audio in accordance with examples of the disclosed technology.

The drawings are for the purpose of illustrating example examples, but those of ordinary skill in the art will understand that the technology disclosed herein is not limited to the arrangements and/or instrumentality shown in the drawings.

### DETAILED DESCRIPTION

### I. OVERVIEW

Home theatre audio configurations can involve an array of playback devices distributed about the listening environment. In some instances, a primary playback device (e.g., a soundbar) can be configured to be placed in a front center position of the listening environment, and one or more satellite playback devices can be placed in various positions about the listening environment. Depending on the type of audio content, the number and type of playback devices, and/or user preferences, satellite playback devices may be placed in front right, front left, rear left, rear right, right side, left side, or other suitable positions relative to the intended listening position.

Typical wireless home theatre approaches assume that individual satellite playback devices output a single audio channel (e.g., a left rear satellite playback device outputs only a left rear audio channel; a right rear satellite playback device outputs only a right rear audio channel). While such single-channel satellite playback devices provide significant benefits over systems that do not utilize satellite playback devices at all, multichannel satellite playback devices can provide additional benefits for the listener. As described in more detail below, by using satellite playback devices capable of outputting multiple audio channels (for example, outputting different audio channels along different sound axes) can provide a more immersive listening experience for the user. Moreover, such multichannel satellite playback devices are better able to capitalize on spatial audio formats (e.g., Dolby Atmos, DTS:X) that allow for a greater number of channels than conventional audio formats.

The use of such multichannel satellite playback devices presents certain challenges, however. For instance, distributing multiple channels of audio content to satellite devices for play back can be infeasible over a home wireless network due to bandwidth constraints, network traffic congestion, etc. Examples of the present technology can address these and other problems by intelligently downmixing incoming audio data into a smaller number of channels for transmission to multichannel satellite playback devices, which can then play back the received audio data for synchronous playback with other playback devices within the environment. In some implementations, the multichannel satellite playback devices can upmix the received audio before playback, while in certain implementations the multichannel satellite playback devices can play back the downmixed audio using arraying techniques that facilitate reproducing, to the extent possible, the original number of channels. The parameters of the downmixing and/or upmixing can be based on, for instance, similarities among two or more audio channels, typical audio channel content, playback device characteristics, play back device placement, room acoustics, listener location, media content, network conditions, or any other suitable conditions.

Another challenge can arise when using multichannel satellite playback devices in conjunction with a soundbar or other similar device configured to output multiple channels. A soundbar (or other suitable primary playback device) typically handles playback responsibilities for at least the front left, center, and front right channels (and optionally left side surround and right side surround in some instances). When front left, center, and front right channels are all output by a single playback device such as a soundbar, playback parameters such as phase and magnitudes of the audio output are inherently seamless across all channels. However, when front left and front right channels are instead or additionally output via discrete front satellite play back devices, there is a risk of mismatch of playback parameters between the devices that can deleteriously affect the user's listening experience. Examples of the present technology can address these and other problems by performing a calibration process among devices within the home theatre zone to determine certain play back parameters (e.g., phase response, magnitude response) of individual playback devices within the zone. Based on these individual parameters, the parameters of one or more of the devices can be adjusted to match those of the other device(s). In some instances, a particular play back device can be selected as the reference device for a given parameter, and the other playback devices within the zone can have their playback modified (e.g., by adjusting a phase response, a magnitude response, etc.) to match that of the reference device. As a result, a more consistent output among the various playback devices can be achieved.

In some instances, using multichannel satellite playback devices can achieve a greater perceived width of audio playback, which can increase the immersiveness of the listening experience. Because multichannel satellite playback devices are capable of outputting audio along a plurality of sound axes, the perceived width of audio playback can be modified by selectively distributing playback responsibilities between the multichannel satellite playback devices and a primary playback device (e.g., a soundbar). Additionally or alternatively, the perceived width of audio playback can be modified by selectively distributing playback responsibilities between the various sound axes of the multichannel satellite play back devices. In some examples, the width of audio playback can be directly controlled by a user, or can be dynamically adjusted in response to certain detected parameters.

In some cases, a user's placement of multichannel satellite playback devices around her environment may differ from the intended placement, either in terms of device location or device orientation. As a result, the audio output by the multichannel satellite playback devices can have unintended properties, such as a side surround channel being directed too far forward or too far rearward of an intended listening location. Examples of the present technology can address these and other problems by modifying playback parameters of multichannel satellite playback devices to compensate for their placement within the environment. As a result, even when a user places multichannel audio satellite playback devices in undesirable locations or orientations, the system can adapt play back to provide an improved listening experience.

Additional aspects of the present technology relate to improving directivity of output for audio transducers, such as those including up-firing transducers. Conventional surround sound audio rendering formats include a plurality of channels configured to represent different lateral positions with respect to a listener (e.g., front, right, left). More recently, three-dimensional (3D) or other immersive audio rendering formats have been developed that include one or more vertical or height channels in addition to any lateral channels. Examples of such 3D audio formats include DOLBY ATMOS, MPEG-H, and DTS:X formats. Such 3D audio rendering formats may include one or more vertical channels configured to represent sounds originating from above a listener. In some instances, such vertical channels can be played back via transducers positioned over a user's head (e.g., ceiling mounted speakers). In the case of soundbars or other multi-transducer devices, an upwardly oriented transducer (herein referred to as an “up-firing transducer”) can output audio along a sound axis that is at least partially vertically oriented with respect to a forward horizontal plane of a playback device. This audio output can reflect off an acoustically reflective surface (e.g., a ceiling) to be directed toward a listener at a target location. Because the listener perceives the audio as originating from point of reflection on the ceiling, the psychoacoustic perception is that the sound originates “above” the listener. In the case of vertical side audio content (e.g., a left front height channel), the content may be output by an array of transducers including at least one up-firing transducer and at least one side-firing transducer and/or forward-firing transducer, depending on the orientation of the playback device. This approach can be particularly useful when vertical content is played back via discrete satellite devices, such as front left, front right, rear left, or rear right satellite playback devices that are equipped with one or more up-firing transducers.

Although up-firing transducers or arrays can usefully enable a listener to localize a sound overhead, the effect may be reduced when a substantial portion of the audio content output by such up-firing transducers propagates in the forward direction, sometimes referred to as forward “leakage.” This effect can be particularly pronounced over certain frequency ranges. Many full-range transducers output midrange and lower frequency sound (e.g., sound at approximately 1.5 kHz or less) substantially omnidirectionally, particularly in the case of transducers having relatively small diameter (e.g. 4″ or smaller). This may be true even if the transducer outputs high frequency sound (e.g., above 1.5 kHz) in a directional manner. As a result, a vertically oriented up-firing transducer may output audio in a manner such that, while a high frequency portion of the output propagates along the vertically oriented axis and reflects off a ceiling to a listener, a mid- or low-frequency portion of the output propagates with less directivity, including propagating along a horizontal axis directly towards the listener without first reflecting off the ceiling. Since at least some of the mid- or low-frequency portion “leaks” along the horizontal direction, the listener's perception of audio output from the up-firing transducer is a combination of the (full-range) output reflected off the ceiling and the mid- and low-frequency output that propagates horizontally from the up-firing transducer. Moreover, the leaked portion will typically reach the listener first since its path length is almost always shorter than that of the reflected output. As a result, the listener may localize the source of the audio output as being the up-firing transducer rather than the reflection point on the ceiling, thereby degrading the immersive audio experience.

Examples of the disclosed technology may address these and other shortcomings by outputting a “null signal” that is configured to at least partially cancel out the undesirable leakage of vertical content along the forward (or other lateral) direction. For instance, simultaneously with outputting vertical channel content via an up-firing transducer (or via an array including an up-firing transducer and one or more side-firing transducers), a forward-firing transducer can output a null signal that destructively interferes with the vertical content along the forward sound axis, thereby reducing the amount of height channel content that reaches a listener along the forward sound axis. The null signal can be generated by phase-shifting the vertical content signal and synchronizing the output such that the null signal destructively interferes with the vertical content output along the forward sound axis. In some implementations, the null signal can be output by an array of transducers, which can include one or more forward-firing transducers and/or one or more side-firing transducers (e.g., a transducer oriented and configured to output audio primarily along a sound axis that is laterally angled with respect to the forward axis of the playback device). In various implementations, the null signal can be restricted to a particular frequency range, for instance between about 500 Hz to about 2.5 kHz, or any suitable frequency range for a given application and configuration of playback devices. This approach may be suitable as higher frequency audio output (e.g., frequencies greater than about 1.5 kHz, 2.0 kHz, 2.5 kHz, or higher) via typical transducers tends to be more directional and thus is less susceptible to forward leakage.

In some examples, as a result of the null signal, the sound pressure level (SPL) of the vertical content that propagates along the forward axis is at least 5 dB less (e.g., 10 dB less) than the SPL of the vertical content that propagates along the up-firing axis (e.g., an axis oriented upwardly at an oblique angle such as +70 degrees from the forward axis). To ensure that the null signal played back via the forward-firing transducer is substantially aligned with the vertical content played back via the up-firing transducer (and optionally via one or more side-firing transducers), the null signal can be time delayed with respect to the output of the vertical content via the up-firing transducer or array. This delay can be configured to compensate for the different path length that the null signal takes to reach the listener (e.g., propagating from the forward-firing transducer) as compared to the vertical content (e.g. propagating from the up-firing transducer or array).

By increasing the directivity of vertical content output (e.g., by canceling out a portion of the forward leakage of such vertical content), the listener's perceived localization of the vertical content can be markedly improved, for instance with less localization on the play back device itself. The net result is enhanced immersiveness, with the user more reliably localizing vertical audio content at an overhead position, notwithstanding the tendency for some vertical content to “leak” along the horizontal direction from an up-firing transducer or array.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

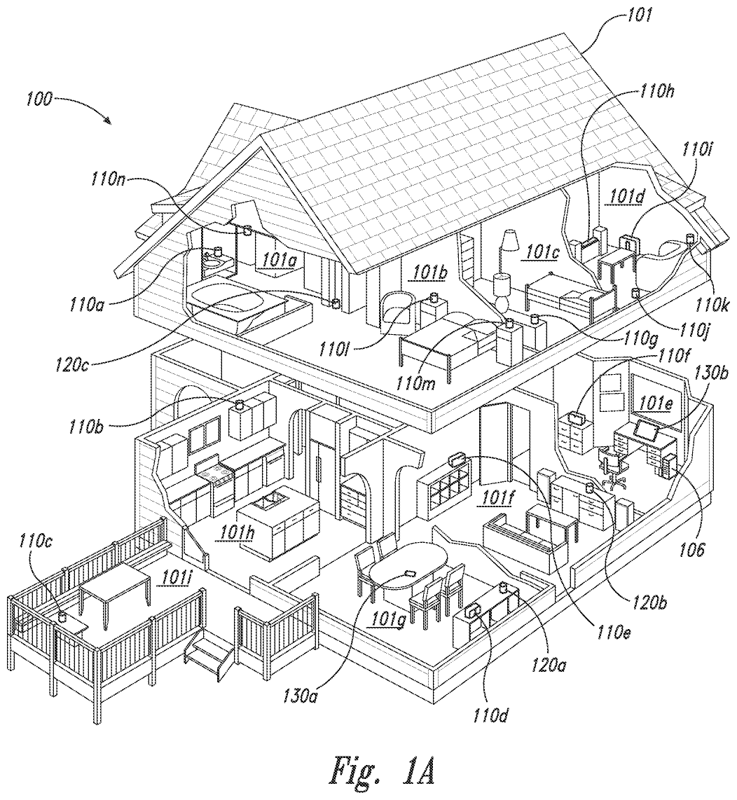

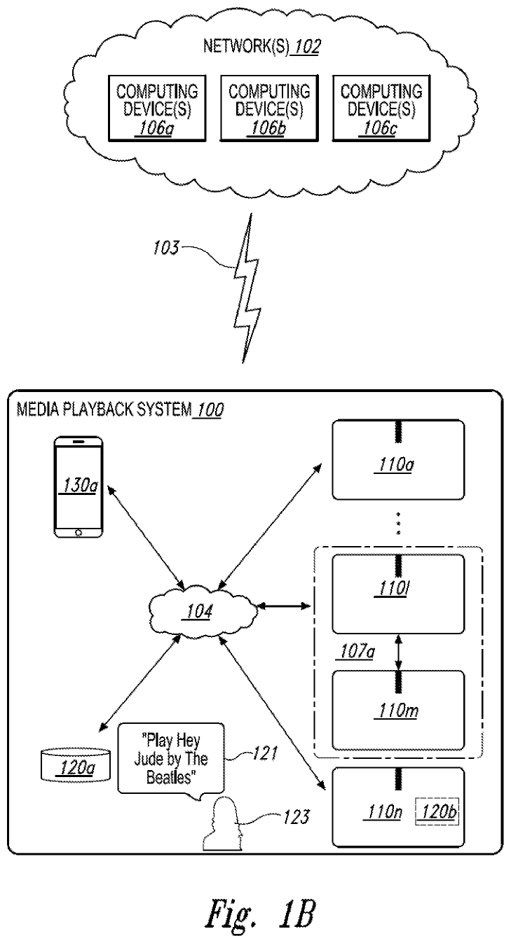

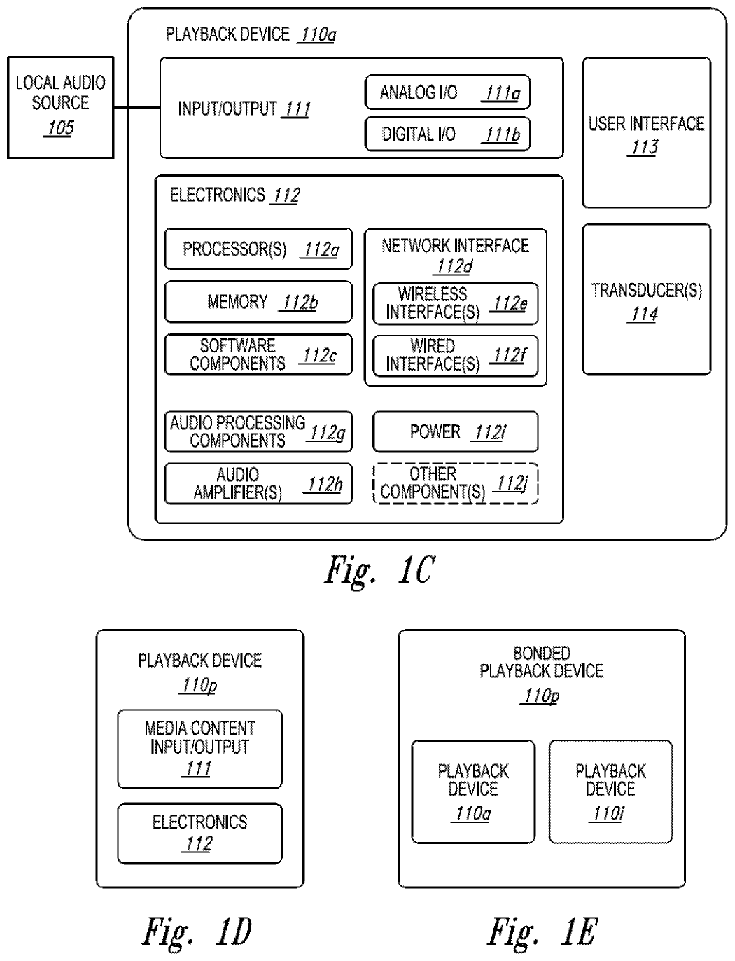

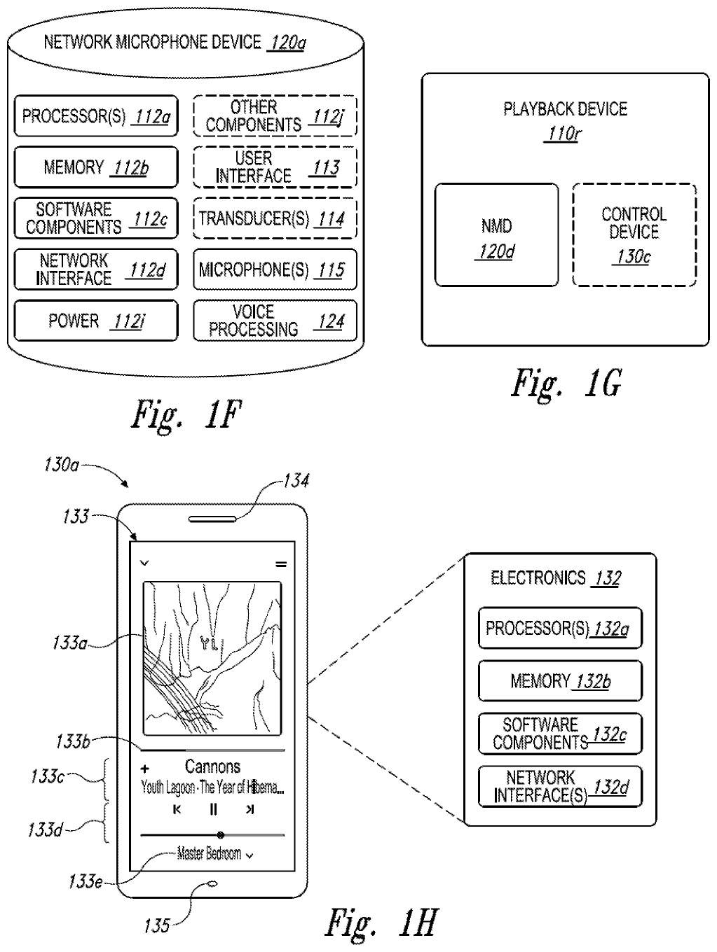

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular examples of the disclosed technology. Accordingly, other examples can have other details, dimensions, angles and features without departing from the spirit or scope of the disclosure. In addition, those of ordinary skill in the art will appreciate that further examples of the various disclosed technologies can be practiced without several of the details described below.

### II. SUITABLE OPERATING ENVIRONMENT

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some examples, a playback device includes one or more transducers or speakers powered by one or more amplifiers. In other examples, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some examples, an NMD is a stand-alone device configured primarily for audio detection. In other examples, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media play back system 100 can play back audio via one or more of the play back devices 110. In certain examples, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some examples, for instance, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various examples of the disclosure are described in greater detail below.

In the illustrated example of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain examples and examples are described below in the context of a home environment, the technologies described herein may be implemented in other types of environments. In some examples, for instance, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some examples, a single playback zone may include multiple rooms or spaces. In certain examples, a single room or space may include multiple playback zones.

In the illustrated example of FIG. 1A, the master bathroom 101a, the second bedroom 101c, the office 10le, the living room 101f, the dining room 101g, the kitchen 101h, and the outdoor patio 101i each include one playback device 110, and the master bedroom 101b and the den 101d include a plurality of play back devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some examples, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some examples, the playback devices 110c and 110f play back the hip hop music in synchrony such that the user perceives that the audio content is being played seamlessly (or at least substantially seamlessly) while moving between different playback zones. Additional details regarding audio playback synchronization among play back devices and/or zones can be found, for example, in U.S. Pat. No. 8,234,395 entitled, “System and method for synchronizing operations among a plurality of independently clocked digital data processing devices,” which is incorporated herein by reference in its entirety.

### a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some examples, the cloud network 102 is further configured to receive data (e.g. voice input data) from the media play back system 100 and correspondingly transmit commands and/or media content to the media play back system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some examples, one or more of the computing devices 106 comprise modules of a single computer or server. In certain examples, one or more of the computing devices 106 comprise one or more modules, computers, and/or servers. Moreover, while the cloud network 102 is described above in the context of a single cloud network, in some examples the cloud network 102 comprises a plurality of cloud networks comprising communicatively coupled computing devices. Furthermore, while the cloud network 102 is shown in FIG. 1B as having three of the computing devices 106, in some examples, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media play back system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some examples, the network 104 comprises a dedicated communication network that the media playback system 100 uses to transmit messages between individual devices and/or to transmit media content to and from media content sources (e.g., one or more of the computing devices 106). In certain examples, the network 104 is configured to be accessible only to devices in the media playback system 100, thereby reducing interference and competition with other household devices. In other examples, however, the network 104 comprises an existing household communication network (e.g., a household WiFi network). In some examples, the links 103 and the network 104 comprise one or more of the same networks. In some examples, for instance, the links 103 and the network 104 comprise a telecommunication network (e.g., an LTE network, a 5G network). Moreover, in some examples, the media playback system 100 is implemented without the network 104, and devices comprising the media playback system 100 can communicate with each other, for example, via one or more direct connections, PANs, telecommunication networks, and/or other suitable communication links.

In some examples, audio content sources may be regularly added or removed from the media playback system 100. In some examples, for instance, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some examples, for instance, the media content database is stored on one or more of the play back devices 110, network microphone devices 120, and/or control devices 130.

In the illustrated example of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media play back system 100. When arranged in the group 107a, the playback devices 110l and 110m can be configured to play back the same or similar audio content in synchrony from one or more audio content sources. In certain examples, for instance, the group 107a comprises a bonded zone in which the playback devices 110l and 110m comprise left audio and right audio channels, respectively, of multi-channel audio content, thereby producing or enhancing a stereo effect of the audio content. In some examples, the group 107a includes additional playback devices 110. In other examples, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated example of FIG. 1B, the NMD 120a is a standalone device and the NMD 120d is integrated into the playback device 110n. The NMD 120a, for example, is configured to receive voice input 121 from a user 123. In some examples, the NMD 120a transmits data associated with the received voice input 121 to a voice assistant service (VAS) configured to (i) process the received voice input data and (ii) transmit a corresponding command to the media play back system 100. In some examples, for instance, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some examples, the analog I/O 111a is an audio line-in input connection comprising, for example, an auto-detecting 3.5 mm audio line-in connection. In some examples, the digital I/O 111b comprises a Sony/Philips Digital Interface Format (S/PDIF) communication interface and/or cable and/or a Toshiba Link (TOSLINK) cable. In some examples, the digital I/O 111b comprises a High-Definition Multimedia Interface (HDMI) interface and/or cable. In some examples, the digital I/O 111b includes one or more wireless communication links comprising, for example, a radio frequency (RF), infrared, WiFi, Bluetooth, or another suitable communication protocol. In certain examples, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some examples, the local audio source 105 includes local music libraries on a smartphone, a computer, a networked-attached storage (NAS), and/or another suitable device configured to store media files. In certain examples, one or more of the playback devices 110, NMDs 120, and/or control devices 130 comprise the local audio source 105. In other examples, however, the media playback system omits the local audio source 105 altogether. In some examples, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some examples, the playback device 110a optionally includes one or more microphones 115 (e.g., a single microphone, a plurality of microphones, a microphone array) (hereinafter referred to as “the microphones 115”). In certain examples, for instance, the playback device 110a having one or more of the optional microphones 115 can operate as an NMD configured to receive voice input from a user and correspondingly perform one or more operations based on the received voice input.

In the illustrated example of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some examples, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some examples, the operations further include causing the playback device 110a to send audio data to another one of the playback devices 110a and/or another device (e.g., one of the NMDs 120). Certain examples include operations causing the play back device 110a to pair with another of the one or more playback devices 110 to enable a multi-channel audio environment (e.g., a stereo pair, a bonded zone).

The processors 112a can be further configured to perform operations causing the play back device 110a to synchronize playback of audio content with another of the one or more playback devices 110. As those of ordinary skill in the art will appreciate, during synchronous playback of audio content on a plurality of play back devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some examples, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the play back devices 110, NMDs 120, control devices 130) of the media playback system 100. In some examples, for instance, the state data is shared during predetermined intervals of time (e.g., every 5 seconds, every 10 seconds, every 60 seconds) among at least a portion of the devices of the media playback system 100, so that one or more of the devices have the most recent data associated with the media play back system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated example of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some examples, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain examples, the network interface 112d includes the wired interface 112f and excludes the wireless interface 112e. In some examples, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some examples, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain examples, one or more of the audio processing components 112g can comprise one or more subcomponents of the processors 112a. In some examples, the electronics 112 omits the audio processing components 112g. In some examples, for instance, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some examples, for instance, the amplifiers 112h include one or more switching or class-D power amplifiers. In other examples, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain examples, the amplifiers 112h comprise a suitable combination of two or more of the foregoing types of power amplifiers. Moreover, in some examples, individual ones of the amplifiers 112h correspond to individual ones of the transducers 114. In other examples, however, the electronics 112 includes a single one of the amplifiers 112h configured to output amplified audio signals to a plurality of the transducers 114. In some other examples, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some examples, the transducers 114 can comprise a single transducer. In other examples, however, the transducers 114 comprise a plurality of audio transducers. In some examples, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain play back devices including, for example, a “SONOS ONE,” “MOVE,” “PLAY:5,” “BEAM,” “PLAYBAR,” “PLAYBASE,” “PORT,” “BOOST,” “AMP,” and “SUB.” Other suitable play back devices may additionally or alternatively be used to implement the playback devices of example examples disclosed herein. Additionally, one of ordinary skilled in the art will appreciate that a playback device is not limited to the examples described herein or to SONOS product offerings. In some examples, for instance, one or more playback devices 110 comprises wired or wireless headphones (e.g., over-the-ear headphones, on-ear headphones, in-ear earphones). In other examples, one or more of the playback devices 110 comprise a docking station and/or an interface configured to interact with a docking station for personal mobile media playback devices. In certain examples, a playback device may be integral to another device or component such as a television, a lighting fixture, or some other device for indoor or outdoor use. In some examples, a playback device omits a user interface and/or one or more transducers. For example, FIG. 1D is a block diagram of a playback device 110p comprising the input/output 111 and electronics 112 without the user interface 113 or transducers 114.

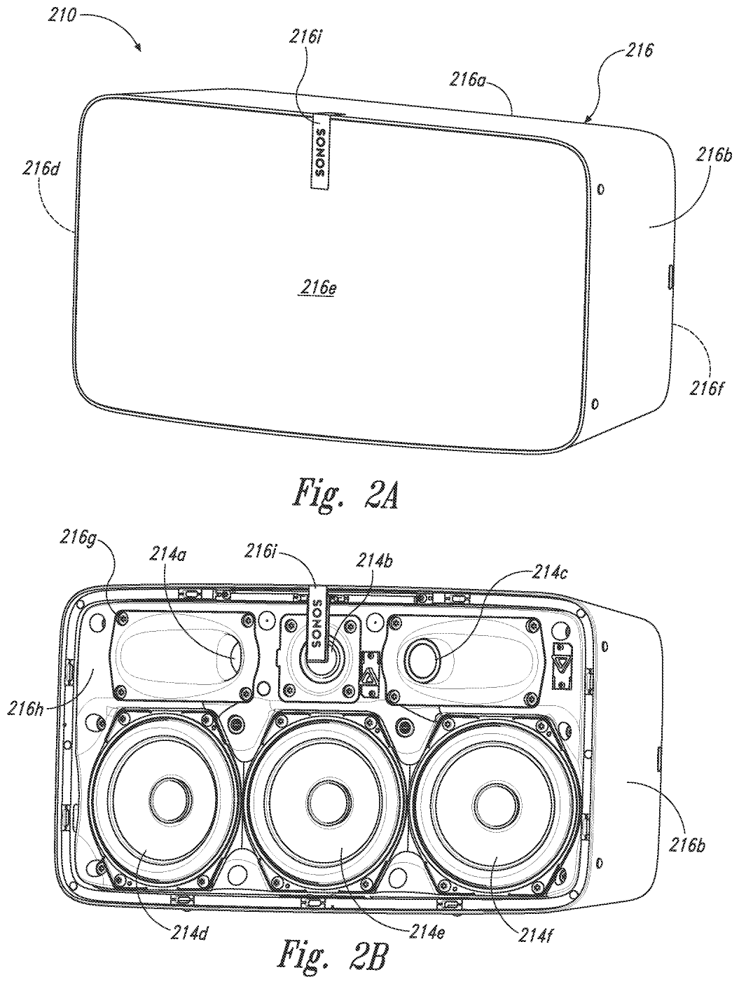

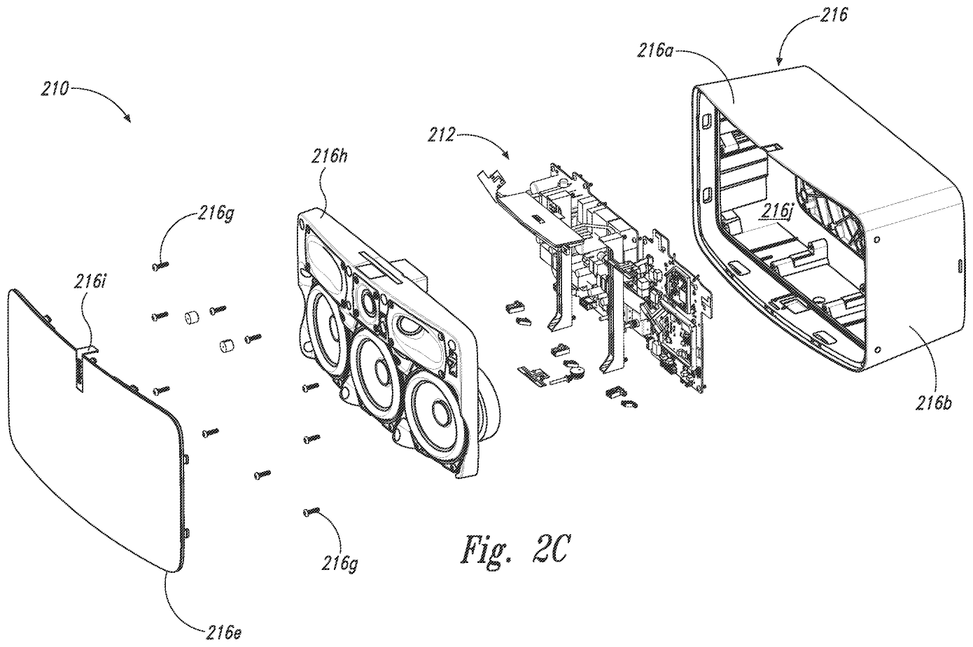

FIG. 1E is a block diagram of a bonded playback device 110q comprising the playback device 110a (FIG. 1C) sonically bonded with the playback device 110i (e.g., a subwoofer) (FIG. 1A). In the illustrated example, the playback devices 110a and 110i are separate ones of the playback devices 110 housed in separate enclosures. In some examples, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the play back devices 110l and 110m of FIG. 1B). In some examples, for instance, the play back device 110a is full-range playback device configured to render low frequency, mid-range frequency, and high frequency audio content, and the playback device 110i is a subwoofer configured to render low frequency audio content. In some examples, the playback device 110a, when bonded with the first playback device, is configured to render only the mid-range and high frequency components of a particular audio content, while the playback device 110i renders the low frequency component of the particular audio content. In some examples, the bonded playback device 110q includes additional playback devices and/or another bonded playback device. Additional playback device examples are described in further detail below with respect to FIGS. 2A-2C.

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the play back device 110a (FIG. 1C) including the processors 112a, the memory 112b, and the microphones 115. The NMD 120a optionally comprises other components also included in the play back device 110a (FIG. 1C), such as the user interface 113 and/or the transducers 114. In some examples, the NMD 120a is configured as a media playback device (e.g., one or more of the play back devices 110), and further includes, for example, one or more of the audio components 112g (FIG. 1C), the amplifiers 114, and/or other playback device components. In certain examples, the NMD 120a comprises an Internet of Things (IoT) device such as, for example, a thermostat, alarm panel, fire and/or smoke detector, etc. In some examples, the NMD 120a comprises the microphones 115, the voice processing components 124, and only a portion of the components of the electronics 112 described above with respect to FIG. 1B. In some examples, for instance, the NMD 120a includes the processor 112a and the memory 112b (FIG. 1B), while omitting one or more other components of the electronics 112. In some examples, the NMD 120a includes additional components (e.g., one or more sensors, cameras, thermometers, barometers, hygrometers).

In some examples, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other examples, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE ® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated example, the control device 130a comprises a smartphone (e.g., an iPhone™. an Android phone) on which media playback system controller application software is installed. In some examples, the control device 130a comprises, for example, a tablet (e.g., an iPad™), a computer (e.g., a laptop computer, a desktop computer), and/or another suitable device (e.g., a television, an automobile audio head unit, an IoT device). In certain examples, the control device 130a comprises a dedicated controller for the media playback system 100. In other examples, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media play back system controller application software, and/or other data associated with the media playback system 100 and the user.

The network interface 132d is configured to facilitate network communications between the control device 130a and one or more other devices in the media play back system 100, and/or one or more remote devices. In some examples, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media play back systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate 'control of the media play back system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated example, the user interface 133 comprises a display presented on a touch screen interface of a smartphone (e.g., an iPhone™, an Android phone). In some examples, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some examples, the one or more speakers comprise individual transducers configured to correspondingly output low frequencies, mid-range frequencies, and/or high frequencies. In some examples, for instance, the control device 130a is configured as a playback device (e.g., one of the playback devices 110). Similarly, in some examples the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some examples, two or more of the microphones 135 are arranged to capture location information of an audio source (e.g., voice, audible sound) and/or configured to facilitate filtering of background noise. Moreover, in certain examples, the control device 130a is configured to operate as playback device and an NMD. In other examples, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. EXAMPLE PLAYBACK DEVICES

FIG. 2A is a front isometric view of a playback device 210 configured in accordance with examples of the disclosed technology. FIG. 2B is a front isometric view of the play back device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some examples, the playback device 210 includes a number of transducers different than those illustrated in FIGS. 2A-2C. For example, the play back device 210 can include fewer than six transducers (e.g., one, two, three). In other examples, however, the playback device 210 includes more than six transducers (e.g., nine, ten). Moreover, in some examples, all or a portion of the transducers 214 are configured to operate as a phased array to desirably adjust (e.g., narrow or widen) a radiation pattern of the transducers 214, thereby altering a user's perception of the sound emitted from the play back device 210.

In the illustrated example of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some examples, however, the playback device 210 omits the filter 216i. In other examples, the playback device 210 includes one or more additional filters aligned with the transducers 214b and/or at least another of the transducers 214.

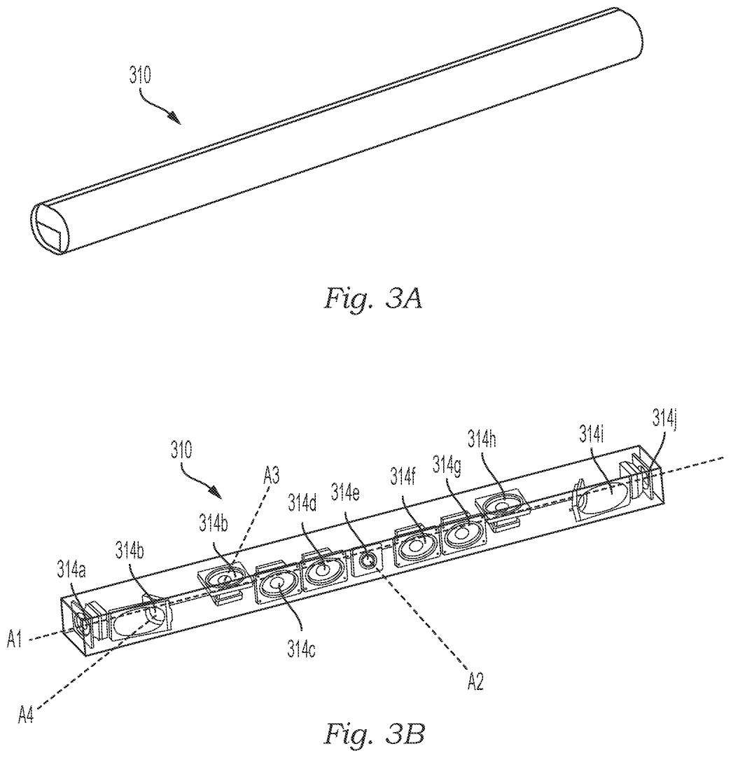

FIG. 3A is a perspective view of a playback device 310, and FIG. 3B shows the device 310 with the outer body drawn transparently to illustrate the plurality of transducers 314a-j therein (collectively “transducers 314”). The transducers 314 can be similar or identical to any one of the transducers 214a-f described previously. In this example, the playback device 310 takes the form of a soundbar that is elongated along a horizontal axis A1 and is configured to face along a primary sound axis A2 that is substantially orthogonal to the first horizontal axis A1. In other examples, the playback device 310 can assume other forms, for example having more or fewer transducers, having other form-factors, or having any other suitable modifications with respect to the example shown in FIGS. 3A and 3B. In various implementations, the playback device 310 can serve as a home theatre primary playback device, and may be placed in a center front position of a home theatre listening environment. In such a configuration, the playback device 310 can play back home theatre audio synchronously with playback via one or more satellite playback devices, which can be arranged about the listening environment in a suitable configuration.

The playback device 310 can include individual transducers 314a-j oriented in different directions or otherwise configured to direct sound along different sound axes. For example, the transducers 314c-g can be configured to direct sound primarily along directions parallel to the primary sound axis A2 of the play back device 310. Additionally, the playback device 310 can include left and right up-firing transducers (e.g., transducers 314b and 314h) that are configured to direct sound along axes that are angled vertically with respect to the primary sound axis A2. For example, the left up-firing transducer 314b is configured to direct sound along the axis A3, which is vertically angled with respect to the horizontal primary axis A2. In some examples, the up-firing sound axis A3 can be angled with respect to the primary sound axis A2 by between about 50 degrees and about 90 degrees, between about 60 degrees and about 80 degrees, or about 70 degrees.

The playback device 310 can optionally include one or more side-firing transducers (e.g., transducers 314a, 314b, 314i, and 314j), which can direct sound along axes that are horizontally angled with respect to the primary sound axis A2. In the illustrated example, the outermost transducers 314a and 314j can be configured to direct sound primarily along the first horizontal axis A1 or at least partially horizontally angled therefrom, while the side-firing transducers 314b and 314i are configured to direct sound along an axis that lies between the axes A1 and A2. For example, the left side-firing transducer 314b is configured to direct sound along axis A4.

In playback devices that do not have such side-firing transducers, side-propagating audio can be achieved by use of arrays, in which the audio output by each transducer sums in manner that the combined output has a directivity and is oriented along a side-propagating axis.

In operation, the playback device 310 can be utilized to play back 3D audio content that includes a vertical component (also referred to herein as a “height component”). As noted previously, certain 3D audio or other immersive audio formats include one or more height channels in addition to any lateral (e.g., left, right, front) channels. Examples of such 3D audio formats include DOLBY ATMOS, MPEG-H, and DTS:X formats. In playback devices that do not have such up-firing transducers, upward-propagating audio can be achieved by use of arrays, in which the audio output by each transducer sums in a manner that the combined output has a directivity and is oriented along a vertically propagating axis.

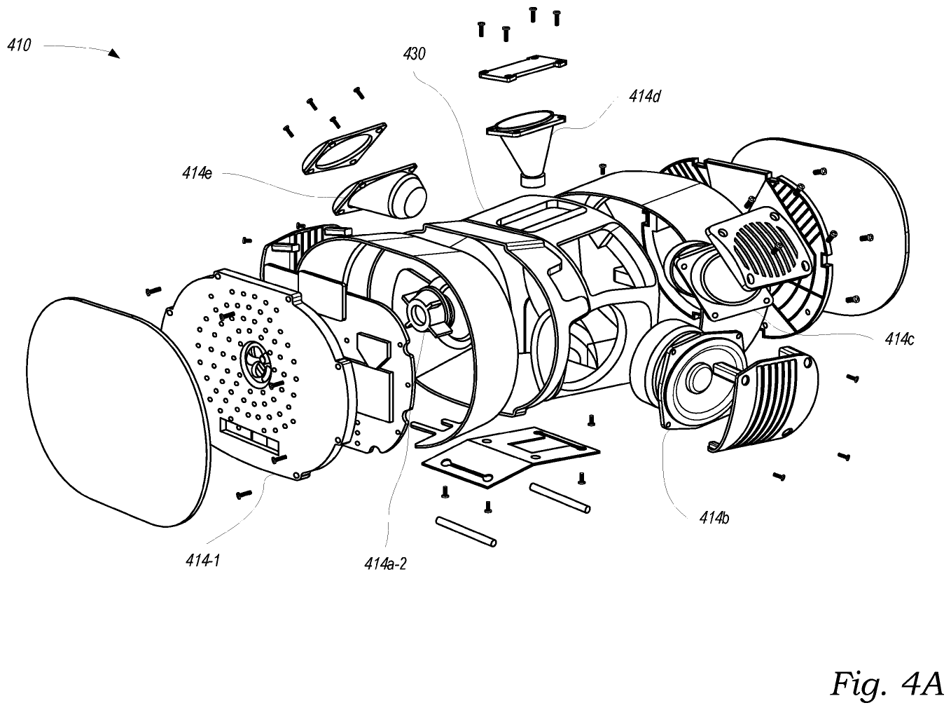

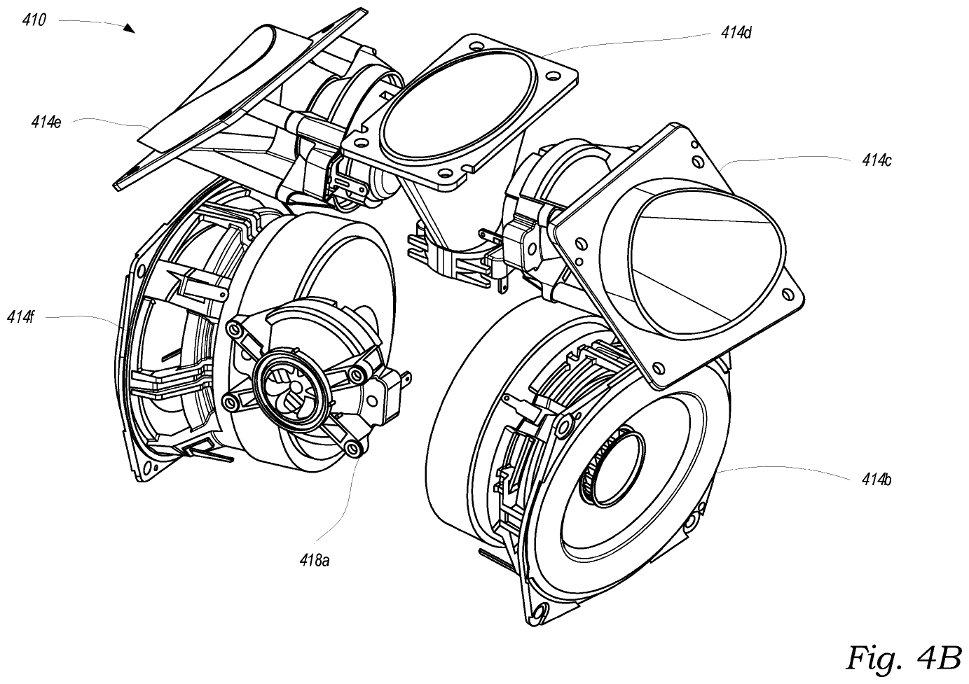

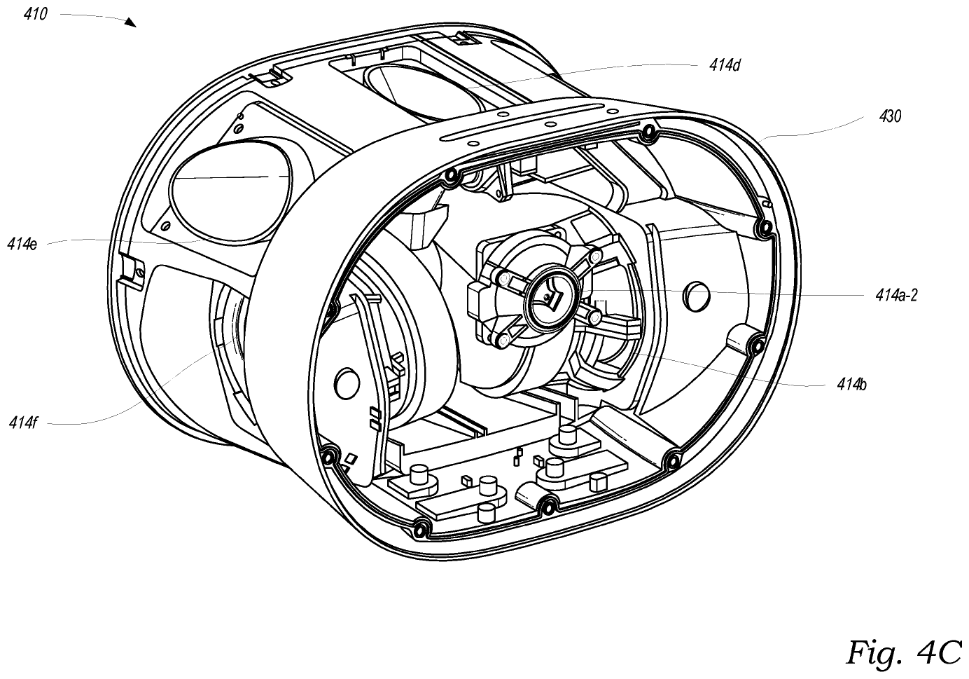

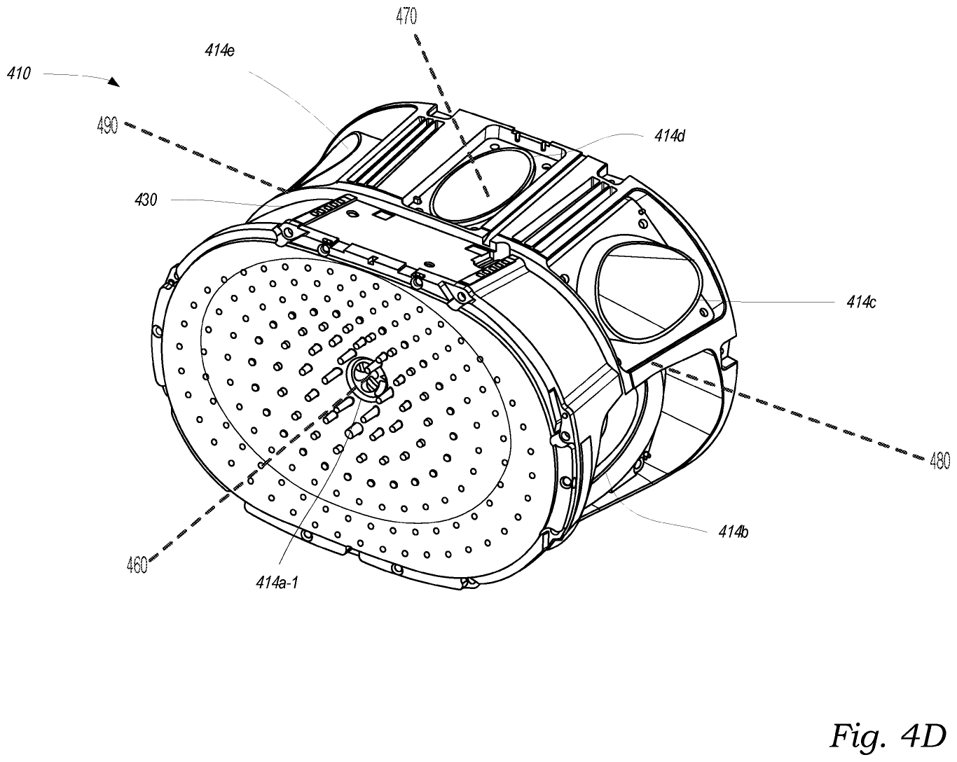

In example implementations, various techniques described herein may be carried out with a playback device that includes multiple audio transducers, and may optionally be used as a multichannel satellite playback device for home theatre applications. By way of illustration, FIG. 4A is an exploded view of a playback device 410 that includes a plurality of speakers 414. In particular, the speakers 414 include a forward firing transducer 414a, a side-firing transducer 414b, a side-firing transducer 414c, an upward-firing transducer 414d, a side-firing transducer 414e, and a side-firing transducer 414f (not shown). The speakers 414 are carried in a housing 430. The playback device 410 may otherwise include components the same as or similar to the play back devices 110a (FIGS. 1C), 210 (FIG. 2A) or 310 (FIG. 3A), which may be carried by the housing 430.

As shown in the exploded view of FIG. 4A, the forward-firing transducer 414a is comprised of several components, including a first component 414a-1 and a second component 414a-b. In assembly, the first component 414a-1 and the second component 414a-b are joined to form the forward-firing transducer 414a. In other examples, the side-firing transducer 414a may be formed from a single component. Within example implementations, the other speakers 414 as well as the other components may be formed from one or more multiple components as well.

Within examples, the speakers may have a particular arrangement relative to one another. FIG. 4B is a partial view of the playback device 410 which illustrates the speakers 414 in an example arrangement. As shown, the forward firing transducer 414a is oriented in a first direction (i.e., forward). The side-firing transducer 414b and the side-firing transducer 414f are implemented as respective woofers and are oriented in second and third directions that are approximately 180° from one another and approximately 90° from the first direction in the horizontal plane.

In this example, three of the speakers 414 are implemented as tweeters. These include the side-firing transducer 414c and the side-firing transducer 414e, which are similarly oriented as the side-firing transducer 414b and the side-firing transducer 414b. The tweeters also include the upward-firing transducer 414d, which is oriented in a fourth direction approximately 70° from the first direction in the vertical plane. As shown, the side-firing transducer 414c, the side-firing transducer 414e, the upward-firing transducer 414d also include respective horns.

The arrangements of the transducers 414 may have particular acoustic effects. For instance, the arrangement of the side-firing transducer 414c and the side-firing transducer 414e may provide an ambient effect when surround content is output via the side-firing transducer 414c and the side-firing transducer 414e respectively. The similar arrangement of the side-firing transducers 414b and the side-firing transducer 414f may have a similar effect. In contrast, the forward-firing transducer 414a has a relatively more direct sound (assuming that the play back device 410 is oriented such that the primary direction of forward-firing transducer 414a is more oriented toward the user(s) relative to the primary direction of output of the side-firing transducers 414c and 414e).

To provide further illustration, FIG. 4C is a view showing the playback device 410 as partially assembled. FIG. 4C shows the housing 430 carrying the side-firing transducer 414b, the up-firing transducer 414d, the side-firing transducer 414e, and the side-firing transducer 414e, as well as the second component 414a-2 of the forward-firing transducer 414a. The first component 414a-1 is not shown in FIG. 4C in order to provide a partial interior view of the housing 430.

FIG. 4D is a further view showing the playback device 410 also as partially assembled (without the exterior speaker grilles and trim). FIG. 4D shows the housing 430 carrying the side-firing transducer 414b, the side-firing transducer 414c, the up-firing transducer 414d, and the side-firing transducer 414e. In this view, the first component 414a-1 of the forward-firing transducer 414a is connected to the second component 414a-2.

As illustrated in FIG. 4D, the transducers 414 of the playback device 410 are arranged to output audio along a variety of sound axes. For instance, the forward-firing transducer 414a is configured to output audio along a forward (or primary) sound axis 460, and the up-firing transducer 414d is configured to output audio primarily along a vertical sound axis 470. The side-firing transducers 414b and 414c are configured to output audio primarily along first a first side sound axis 480, either individually or in combination. Additionally opposing side-firing transducers 414e and 414f (not shown in FIG. 4D) are configured to output audio primarily along a second side axis 490, either individually or in combination.

As illustrated, the vertical sound axis 470 is vertically angled with respect to the forward sound axis 460. In some examples, vertical sound axis 470 can be angled with respect to the forward sound axis 460 by between about 50 degrees and about 90 degrees, between about 60 degrees and about 80 degrees, or about 70 degrees. The first side sound axis 480 and the second side sound axis 490 can each be horizontally angled with respect to the forward sound axis 460, for example by about 90 degrees from the forward sound axis 460, and about 180 degrees from one another. In at least some implementations, one or both of the side sound axes 480, 490 are also angled vertically with respect to the forward sound axis 460, for example by 10, 20, 30, 40 degrees or more.

In operation, the playback device 410 can be utilized to play back 3D audio content that includes a vertical component, either as a standalone device or as one component of a home theatre arrangement (e.g., with the playback device 410 serving as a home theatre primary, front surround, rear surround, or other discrete satellite playback device). As noted previously, certain 3D audio or other immersive audio formats include one or more vertical channels in addition to any lateral (e.g., left, right, front) channels. Examples of such 3D audio formats include DOLBY ATMOS, MPEG-H, and DTS:X formats.

### IV. EXAMPLE TECHNIQUES FOR HOME THEATRE AUDIO PLAYBACK WITH MULTICHANNEL SATELLITE PLAYBACK DEVICES

Home theatre audio configurations can involve a number of discrete playback devices distributed about the listening environment. In some instances, a primary playback device (e.g., a soundbar) can be configured to be placed in a front center position of the listening environment, and one or more satellite playback devices can be placed in various positions about the listening environment. Depending on the type of audio content, the number and type of play back devices, and/or user preferences, satellite playback devices may be placed in front right, front left, rear left, rear right, right side, left side, or other suitable positions relative to the intended listening position. Although conventional home theatre configurations utilize single-channel satellite playback devices, employing multichannel satellite playback devices can achieve a more immersive listening experience. Employing such multichannel satellite playback devices-each of which may be capable of outputting a plurality of discrete audio channels along a plurality of sound axes-also present challenges in some contexts. A number of techniques are described herein for taking advantage of the increased performance of multichannel satellite playback devices while avoiding or overcoming the potential challenges associated with their use.

### a. Home Theatre Audio Data Distribution for Multichannel Satellite Playback Devices

One potential drawback of using multichannel satellite playback devices for a home theatre arrangement arises due to limitations for data transfer over a wireless network. As the number of playback devices in the home theatre zone increases, and the number of channels handled by each playback device also increases, the total number of channels to be wirelessly transmitted over a network for synchronous playback may exceed the available data transmission limits. For example, consider a home theatre zone including a primary playback device (e.g., a soundbar or another playback device connected to and/or comprising a display device) and at least two multichannel rear satellite playback devices. Each multichannel rear satellite playback device may be capable of outputting three or more individual audio channels (e.g., side surround, rear surround, rear height), which would necessitate transmitting three data channels from the primary playback device to each rear satellite playback device, resulting in at least six total channels to be wirelessly transmitted. If discrete front left and right satellite playback devices and one or more subwoofers are also added, the primary playback device may need to transmit 12 or more data channels. As modern wireless environments can be quite congested with network traffic, it may not be feasible for a device (e.g., a home theatre primary playback device) to transmit all channels to the various playback devices.

Examples of the present technology can address these and other problems by intelligently downmixing incoming audio data into a smaller number of channels for transmission to multichannel satellite playback devices, which can then upmix the received audio data for synchronous play back with other playback devices within the environment. For example, rather than transmit six data channels of six full frequency audio spectrum channels, the media playback system can intelligently downmix the data into a smaller number of channels for wireless transmission to the satellite playback devices. The satellite playback devices may then receive the downmixed data, and upmix the received channels for playback. The parameters of the downmixing and/or upmixing can be based on, for instance, similarities among two or more audio channels, typical audio channel content, playback device characteristics, playback device placement, room acoustics, listener location, media content, network conditions, or any other suitable conditions.

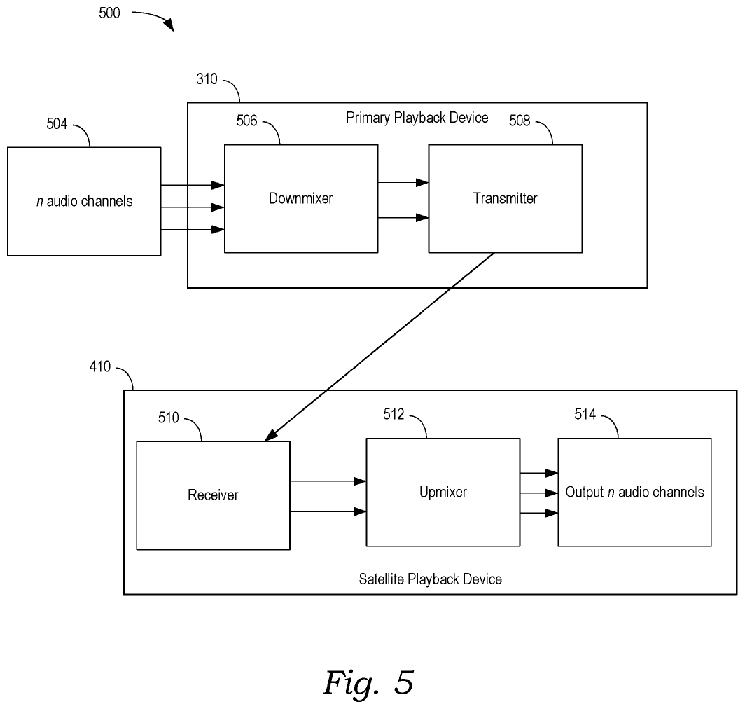

FIG. 5 is a schematic block diagram of a system 500 for distributing audio data to multichannel satellite playback devices. The system 500 illustrates a portion of an audio processing chain involving a primary playback device such as the primary play back device 310 of FIGS. 3A and 3B (e.g., a soundbar or other suitable playback device) and a satellite playback device 410 (e.g., a multichannel playback device). Although only a single satellite play back device 410 is shown, in various implementations the audio distribution scheme shown here can be extended to any number of discrete satellite playback devices. In the illustrated example, the primary play back device comprises a single playback device. In some examples, however, the system 500 comprises two or more primary playback devices. Moreover, in some examples, the primary playback device 310 comprises a display device (e.g., a television, projector, or other suitable video display device) that transmits audio directly to the satellite playback device 410. In certain examples, the primary playback device 310 lacks transducers and/or amplifiers and comprises a media device connected (e.g., via a wired connection, via a wireless connection, via a direct connection in contact with an interface such as an HDMI interface) to a display device. For instance, the primary playback device 310 may comprise a streaming stick, a set-top box, a dongle, etc.

With reference to FIG. 5, the primary playback device 310 receives and/or decodes audio data 504 which includes n audio channels. The number of audio channels can vary depending on the particular audio content, the encoding format, etc. In various examples, the audio data 504 can be received over a physical link to an audio source (e.g., eARC connection to a display device) or over a wireless link to an audio source (e.g., network connection to remote computing devices associated with a media content service).

The primary playback device 310 includes a downmixer 506, which can take the form of circuitry and/or software components configured to receive audio data having n channels and to output audio data having m channels, where m<n. For example, three incoming audio channels can be downmixed to two channels. In various examples, the downmixer 506 can be configured to modify the incoming n audio channels according to a downmixing scheme, which optionally can vary according to certain parameters. For instance, the downmixer 506 can downmix more or less aggressively (e.g., a greater or lesser reduction in the number of channels) under certain conditions. In some instances, the downmixer 506 may not downmix the incoming n audio channels at all, but instead may pass through the incoming audio data 504 without modification.

The downmixed audio data (e.g., having m audio channels) is then passed to a transmitter 508 (e.g., a network interface or other communication component(s)), which transmits the downmixed audio data to a corresponding receiver 510 (e.g., a network interface or other communication component(s)) of the satellite play back device 410. The received audio data is then passed to an upmixer 512 of the satellite playback device. The upmixer 512 can take the form of circuitry and/or software components configured to receive audio data having m signals and to output audio data having n signals, where m<n. For example, a received two channels of downmixed audio data can be upmixed via the upmixer 512 to output three channels of audio data. The satellite playback device 410 then outputs n audio channels as shown in block 514. This can involve playing back the n audio channels via a plurality of transducers of the satellite playback device 410. In various examples, the n audio channels can be output via arraying techniques such that some or all of the channels can be output via a plurality of transducers, and a single transducer can participate in outputting more than one channel. In some instances, a single transducer can output only a single audio channel (e.g., an up-firing transducer may output only a rear height audio channel). In various examples, the downmixing and upmixing process can be lossy or lossless.

In various implementations, the primary playback device 310 may downmix only a subset of the total incoming audio channels. For example, for audio encoded in a 7.1.4 format, the incoming audio can include 12 total channels: center, front left, front right, front right height, front left height, right side surround, left side surround, rear right surround, rear left surround, rear right height, rear left height, and low-frequency effects (LFE). If the system 500 includes two discrete rear satellite playback devices and a discrete subwoofer, then the primary playback device 310 may play back the center, front left, front right, front right height, and front left height channels without the need for downmixing (because these channels need not be transmitted from the primary playback device 310 to other devices). The primary playback device 310 may, however, transmit to each of the rear satellite playback devices 410 data corresponding to three channels of audio data: right side surround, right rear surround, and right rear height for a right rear satellite playback device, and left side surround, left rear surround, and left rear height for a left rear satellite playback device. For transmission of these channels, the playback device 310 may downmix each batch of audio channels for transmission to a respective satellite playback device 410. Additionally, the LFE audio data can be transmitted from the primary playback device 310 to the subwoofer, optionally without any downmixing or other compression scheme.

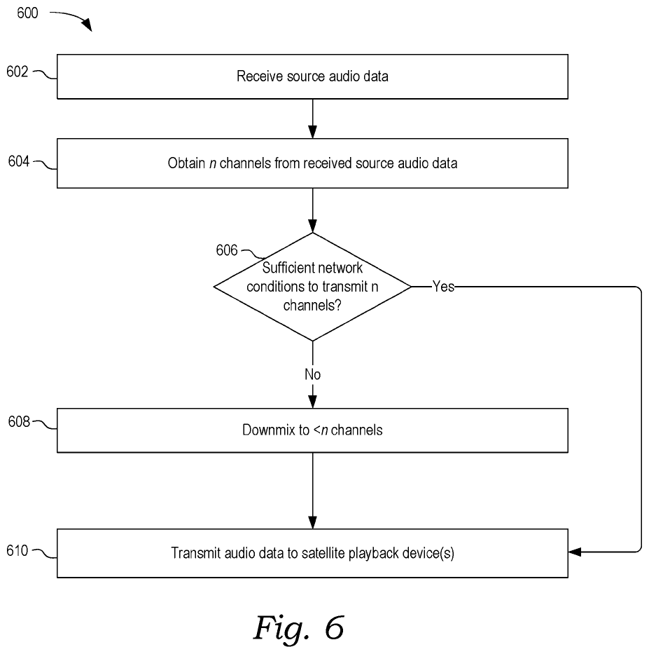

FIG. 6 is a block diagram of an example method 600 for distributing audio data to multichannel satellite playback devices. For the method 600 and for the other methods disclosed herein, the method can be implemented by any of the devices described herein, or any other devices now known or later developed. Various examples of the methods disclosed herein include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation. In addition, for the method 600 and for other processes and methods disclosed herein, the flowcharts show functionality and operation of possible implementations of some examples. In this regard, each block may represent a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIG. 6 may represent circuitry that is wired to perform the specific logical functions in the process.

With reference to FIG. 6, the method 600 begins at block 602, which involves receiving, at a playback device, audio source data. The audio source data can be received over wired or wireless connection to an audio source, and can be encoded in any suitable format. Examples include home theatre audio formats such as Dolby home theatre formats (e.g. 5.1.2, 5.1.4, 7.1.2, 7.1.4, Atmos, etc.). In some examples, the playback device that receives the source audio data can be a home theatre primary playback device, which can take the form of a soundbar or other suitable device. In some instances, the playback device that receives the audio source data may not itself be involved in playing back home theatre audio content, but instead may coordinate playback via other playback devices in the environment.

The method 600 continues in block 604, which involves obtaining n channels from the received source audio data. The number of channels will depend on the particular audio format of the audio source data. In decision block 606, the media playback system (e.g., the primary playback device, another playback device within the environment, or other computing device associated with the media playback system) determines if network conditions are sufficient to transmit n channels of audio data to satellite playback devices. This determination can involve, for example, assessing the file size of the various audio channels, the data transfer rate, the available bandwidth, and/or other parameter(s) of the network (e.g., a local wireless area network, personal area network (PAN) such as an ad hoc Bluetooth network, etc.) to determine whether transmission of the necessary channels is feasible. As noted above, in some implementations the audio content can have a greater number of channels than the n channels that are transmitted to satellite play back devices for play back. In some examples, the evaluation can be predetermined (e.g., only two data channels per satellite playback device), while in others the evaluation can be based on detected network conditions.

If, in decision block 606, network conditions are sufficient (e.g., the available bandwidth and data transfer speeds are sufficient for the amount of data contained in the audio channels to be transmitted to satellite playback device(s)), then the method 600 proceeds to block 610 with transmitting the audio data to satellite playback device(s) for playback. This can involve, for example, sending a first subset of the n channels to a first satellite playback device for playback, and a second subset of the n channels (which may be partially overlapping or wholly non-overlapping with the first subset) to a second satellite playback device for playback. The playback devices of the home theatre zone (which can include the primary playback device that transmitted the n audio channels) can then play back audio in synchrony.

If, in decision block 606, the network conditions are not sufficient (e.g., the available bandwidth and/or data transfer speeds are insufficient for the amount of data contained in the audio channels to be transmitted to satellite playback device(s)), then the method 600 proceeds to block 608 to downmix the audio content to a smaller number of channels. For instance, if three channels are configured to be played back via a particular satellite playback device, these three channels can be downmixed to two channels for transmission. In block 610, the method 600 involve transmitting the audio data (which includes the downmixed channels) to the satellite playback device(s) for playback. As noted previously, in some examples the satellite playback devices can upmix the received audio content for playback.

The process illustrated in FIG. 6 can be performed intermittently when a new audio source is detected, or may be performed continuously on incoming audio content, such that as network conditions improve or the audio data size is reduced, the media play back system may cease downmixing the audio channels for transmission. Conversely, the media play back system may reinstitute downmixing if the network conditions again become insufficient.

In some examples, the particular downmixing scheme applied to the audio channels (e.g., via downmixer 506 (FIG. 5) or as applied in block 608 (FIG. 6), can vary depending on one or more input parameters. For example, the primary playback device can receive or otherwise obtain one or more input parameters, and based on the parameters may vary between a first downmixing scheme and a second downmixing scheme. The various downmixing schemes can vary in more or less aggressively downmixing channels (e.g., with a greater or lesser reduction in total number of channels). In some examples, the downmixing schemes can vary with respect to a cutoff frequency, below which audio content from all channels are combined into a single channel.

In various implementations, the input parameter(s) can include one or more of an audio content parameter (e.g., type of audio content, number of incoming channels, etc.), a device location parameter (e.g., device location relative to listening location), a listener location parameter (e.g., a listener location relative to the device or to the environment), a playback responsibilities parameter (e.g., whether a particular satellite playback device is a rear satellite play back device or a front satellite playback device), or an environmental acoustics parameter (e.g., characterizing the acoustic properties of the listening environment, such as data obtained during a spectral calibration procedure).

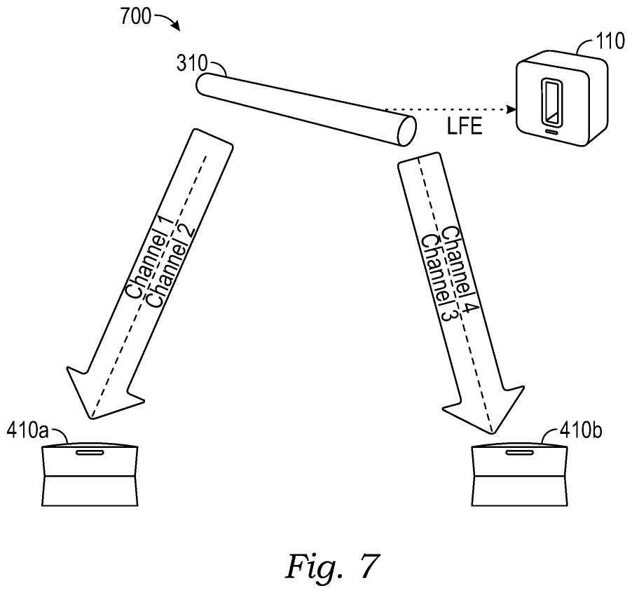

FIG. 7 is a schematic diagram of a system 700 for distributing audio data to multichannel satellite playback devices. The system 700 can be configured for 7.1.4 home theatre audio playback (i.e. seven lateral or ear-level channels: front left, center, front right, left side surround, left rear, right rear, and right side surround; one LFE channel; and four height channels: front left height, front right height, rear left height and rear right height). As shown, the system 700 can include a primary playback device 310 (e.g., a soundbar or other suitable playback device), a subwoofer 110, and two multichannel satellite playback devices 410a and 410b. An LFE data channel can be transmitted from the primary playback device 310 to the subwoofer 110, and two data channels can be transmitted to each of the satellite playback devices 410 (e.g., data channels 1 and 2 transmitted to first satellite playback device 410a, and data channels 3 and 4 transmitted to second satellite playback device 410b). In some implementations, these data channels include downmixed audio channels, for example a downmix from three channels of audio content into two data channels.

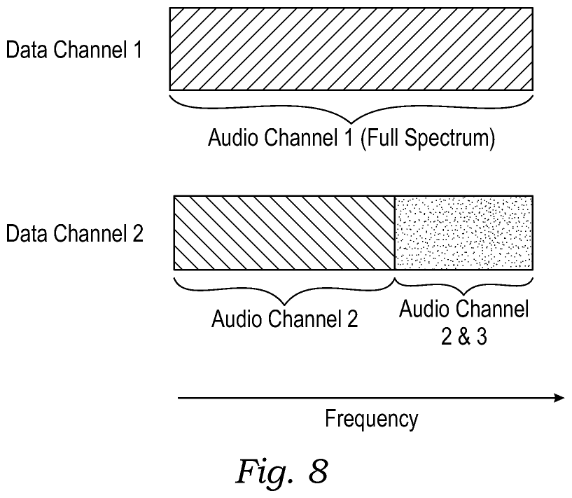

To accommodate playback of three channels via the satellite playback devices 410 while only transmitting two data channels, the satellite audio channels can be downmixed (e.g., via the primary play back device 310). One example of such downmixing can is shown in FIG. 8, which illustrates a distribution of audio channels among data channels for transmitting audio data to a multichannel satellite playback device 410. As shown, the first data channel can include full frequency content of a first audio channel (e.g., side surround content), while the second data channel includes low-and mid-frequency content of a second audio channel (e.g., rear surround content) and mid-and high-frequency content of audio channel 2 and audio channel 3 (e.g., rear height content). In some examples, this downmixing scheme can be adjusted based on relative similarities of the audio content among different audio channels, content type, network conditions, room acoustics, device placement, device orientation, or other relevant parameters.

In some examples, downmixing n channels of satellite audio data to m channels of satellite audio data according to a first downmixing scheme can include (i) mapping a first channel of the n source channels to a first channel of the m downmixed channels (ii) mapping a first portion of a second channel of the n source channels to a first portion of a second channel of the m downmixed channels, and (iii) mapping a second portion of a third channel of the n source channels to a second portion of the second channel of the m downmixed channels. As a result, three channels are downmixed into two channels. Additionally or alternatively, downmixing the n channels of satellite audio data to m channels of audio satellite data according a downmixing scheme can include mapping a second portion of the second channel of the n source channels to the second portion of the second channel of the m downmixed channels such that the second portion of the second channel of the m downmixed channels comprises a combination of (i) the second portion of the second channel of the n source channels and the second portion of the third channel of the n source channels.

In some examples, the relationship between audio channels and data channels may change based on, for instance, content type, content source, network conditions, etc. In some examples, the arrangement of audio channels within the available data channel bandwidth may be based on manual input. Referring back to FIG. 7, after the satellite device receive 410a the downmixed audio (e.g., including the two data channels shown in FIG. 8), the satellite playback device 410a can upmix the received audio data to obtain the individual components of audio channels 2 and 3 and output each of audio channels 1, 2, and 3 via the appropriate transducer(s).

### b. Playback Device Parameter Determination and Adjustment

Additional challenges can arise when using multichannel satellite playback devices in conjunction with a soundbar or other similar device configured to output multiple channels of audio content. In home theatre arrangements, a soundbar (or other suitable primary playback device) typically handles playback responsibilities for at least the front left, center, and front right channels (and optionally additional channels in some instances, such as left side surround, right side surround, right front height, and left front height). When front left, center, and front right channels are all output by a single playback device such as a soundbar, playback parameters such as phase and magnitudes of the audio output are expected to be inherently seamless across all channels. However, when front left and front right channels are additionally or instead output via discrete front satellite playback devices, there is a risk of mismatch of playback parameters between the devices that can deleteriously affect the user's listening experience. For instance, if the phase response and/or magnitude response of the playback devices are not well matched, there can be constructive and/or destructive interference at different frequencies, resulting in an undesirable unevenness in the combined audio output. Examples of the present technology can address these and other problems by performing a calibration process among devices within the home theatre zone to determine certain playback parameters (e.g., phase response, magnitude response) of individual playback devices within the zone. Based on these individual parameters, the parameters of one or more of the devices can be adjusted to match those of the other device(s). In some instances, a particular play back device can be selected as the reference device for a given parameter, and the other playback devices within the zone can have their playback modified (e.g., by adjusting a phase response, a magnitude response, etc.) to match that of the reference device. As a result, a more consistent output among the various playback devices can be achieved.

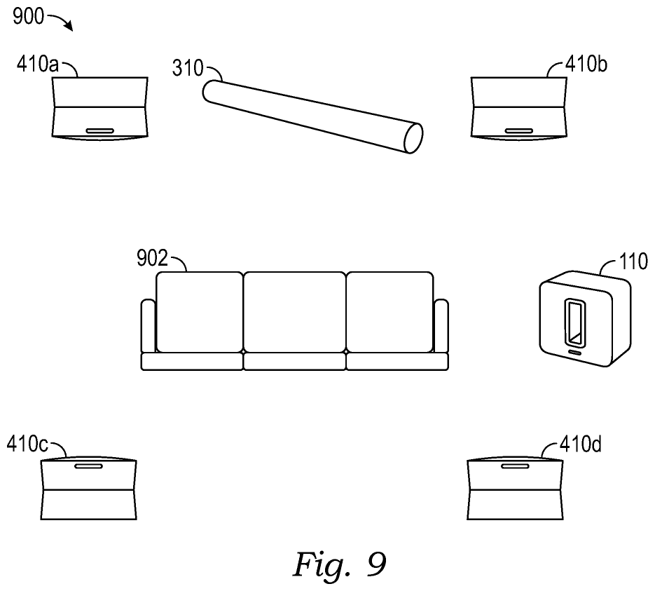

FIG. 9 illustrates a home theatre environment including a media playback system 900 arranged about an intended listening location 902 (indicated as a couch). The media playback system 900 includes a primary playback device 310 (e.g., a soundbar or other suitable playback device), a subwoofer 110, and four discrete multichannel play back devices 410a-d, with playback devices 410a and 410b arranged as front left and front right satellite play back devices, respectively, and play back devices 410c and 410d arranged as rear left and rear right satellite playback devices, respectively. In this arrangement, playback responsibilities can be distributed among the various playback devices in a number of ways. In some examples, the primary playback device 310 can output at least a center channel, while the front left satellite playback device 410a outputs at least a front left channel and the front right satellite playback device 410b outputs at least a front right channel. Optionally, the front left and front right satellite playback devices 410a and 410b can also output at least a portion of left side surround, left front height, right side surround, and right front height channels, respectively. Similarly, rear satellite playback devices 410c and 410d can output right rear and left rear channels, respectively. Optionally, the rear satellite playback devices 410c and 410d can also participate in outputting left side and right side surround channels, respectively.

While the various playback devices of the media playback system 900 are configured to play back home theatre audio content in synchrony, in some instances audio output by the devices may not blend together as well as desired. Typical home theatre audio is mixed as though each channel is output via a dedicated loudspeaker that is identical (e.g., separate and identical loudspeakers for center, front left, and front right devices). Because the arrangement of the media playback system 900 may not have this characteristic, it can be useful to calibrate playback characteristics of one or more devices within the media play back system 900 to more closely match their respective outputs (e.g., to one another, and/or collectively to a desired target output). In some instances, this can involve adjusting a characteristic phase response and/or a characteristic magnitude response of playback for one or more of the devices. In some instances, a particular one of the play back devices can be selected as a reference device for one or more characteristics (e.g., magnitude response, or phase response, or both), and the other playback devices can be calibrated to match the characteristics of the reference device. In various examples, the characteristics (e.g., phase response and/or magnitude response) can be detected for one or more devices, or may be obtained by lookup tables that include characteristic data for a given make and model of playback device. Modifications to the characteristic phase response and/or magnitude response for a given playback device can be achieved by using suitable signal processing techniques, for example subjecting the audio for a given playback device to appropriate filtering operations (e.g., using finite impulse response (FIR) filter or other suitable filter).

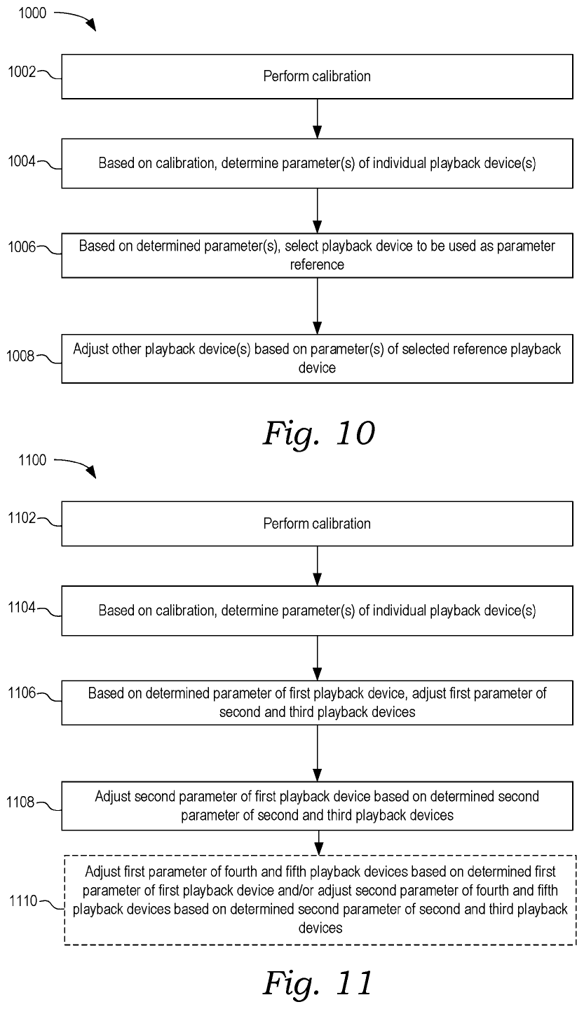

FIG. 10 is a block diagram of a method 1000 for determining and adjusting playback device parameters. The method 1000 begins in block 1002 with performing a calibration process, and in block 1004, based on the calibration process, the determining parameter(s) of individual playback device(s). In various examples, the calibration process can involve obtaining real-world data characterizing the output of each playback device. For instance, one or more microphones (e.g., of a control device such as a smartphone, of one of the other playback devices within the environment, of the same play back device, or other microphone(s) not associated with a playback device) can be used to capture sound data while a given play back device outputs suitable audio for calibration (e.g., a chirp, sweep, or other predefined audio output). This captured sound data can then be used to obtain characteristic play back parameters (e.g., phase response and/or magnitude response). This process may be repeated for each playback device (sequentially, concurrently, or some combination thereof) until playback parameters are determined for each playback device.

Additionally or alternatively, the parameter(s) of the individual playback devices can be obtained by using pre-existing characteristic data (e.g., lab tests for a given make and model of a playback device can provide characteristic phase response and/or magnitude response). In such instances, the parameters can be determined by accessing a lookup table, querying remote computing devices storing the parameter data, or any other suitable approach. In the configuration shown in FIG. 9, the parameters (e.g., phase response and/or magnitude response) for each of the primary playback device 310, the satellite playback devices 410a-d, and/or the subwoofer 110 can be obtained.

Referring back to FIG. 10, at block 1006, the method 1000 involves selecting, based on the determined parameter(s), a particular playback device to be used as a reference device. And in block 1008, the method 100 includes adjusting the other playback device(s) based on the parameter(s) of the selected reference device. In various examples, a single play back device may serve as a reference device for a plurality of characteristics (e.g., phase response and magnitude response). In some instances, a first playback device may serve as a reference device for a first characteristic (e.g., phase response) and a second playback device may serve as a reference device for a second characteristic (e.g., magnitude response). In each case, one or more of the other playback devices within the media playback system may then be adjusted (e.g., having one or more filters applied) such that its audio output more closely matches that of the reference device.

For example, in the configuration shown in FIG. 9, the primary playback device 310 may be selected as the reference device for a phase response, while the front left satellite playback device 410a may be selected as the reference device for a magnitude response. Based on these determinations, the other playback devices (e.g., satellite playback devices 410a-d and/or the subwoofer 110) can be adjusted such that their phase responses more closely mimic that of the primary playback device 310. Additionally, the other playback devices (e.g., primary playback device 310, satellite playback devices 410b-d, and/or the subwoofer 110) can each be adjusted such that their magnitude responses more closely mimic that of the front right satellite playback device 410a.

Once suitable adjustments have been made, the play back devices can play back audio content in synchrony. By virtue of these characteristic adjustments, the combined audio output can be more evenly matched, reducing undesirable interference at the intended listening location.

In various examples, the reference device may be selected based on characteristics of the individual playback devices, such as audio output capabilities (e.g., selecting more highly capable playback devices as a reference device, based on dynamic range, low-frequency extension, etc.), processing capabilities (e.g., selecting a device having greater computational resources such as faster processor, greater amount of memory, etc.), power parameters (e.g., portable vs. plugged-in devices), or other suitable characteristics of the individual playback devices. The reference device(s) can also be selected at least in part based on their assigned playback responsibilities (e.g., selecting a primary playback device (or a device assigned playback responsibilities for the center channel) as a reference device for one or more parameters), based on listener location (e.g., device nearest to the listener can be the reference device), or any other suitable characteristic of the environment, listener, or playback devices.

FIG. 11 illustrates another example method 1100 for determining and adjusting playback device parameters. Blocks 1102 and 1104 can be similar to blocks 1002 and 1004 described above, and involve performing a calibration procedure and, based on the calibration procedure, determining parameter(s) (e.g., phase response, magnitude response) of individual playback devices within the home theatre zone. In block 1106, the method 100 involves adjusting a first parameter of second and third playback devices based on a determined parameter of a first playback device. For example, in the configuration shown in FIG. 9, a phase response of the front satellite playback devices 410a and 410b can be adjusted based on a determined phase response of the primary playback device 310.

Referring back to FIG. 11, at block 1108, a second parameter of the first play back device is adjusted based on a determined second parameter of the second and third playback devices. For instance, in the arrangement shown in FIG. 9, the magnitude response of the primary play back device 310 can be adjusted based on the determined magnitude responses of the front satellite playback devices 410a and 410b.

With reference to FIG. 11, optionally in block 1110, the method 1100 involves adjusting a first parameter of fourth and fifth playback devices based on the determined first parameter of the first playback device, and/or adjusting a second parameter of fourth and fifth playback devices based on the determined second parameter of the second and third play back devices. For example, with reference to FIG. 9, the rear satellite playback devices 410c and 410d can each have their phase response adjusted based on the determined phase response of the primary playback device 310, and can also each have their magnitude response adjusted based on the determined magnitude response of the front satellite playback devices 410a and 410b.

In some examples, these calibration and adjustment procedure can be performed in whole or in part based on certain trigger conditions, such as adding a new device to the bonded zone (e.g., the home theatre zone), removing a device from the bonded zone, receiving a request to assign different playback responsibilities within the bonded zone (e.g., moving a rear satellite playback device to a front rear satellite playback device position), determining that one or more playback devices have moved positions within the room (e.g., using acoustic localization, on-board motion sensors (e.g., accelerometer, gyroscope, etc., or other localization techniques), or other such trigger condition. In these and other instances, a new reference device for one or more playback parameters can be selected, which may be the same or a different device as was previously selected as a reference device.

In various examples, additional calibration procedures can be performed before or after the above-described calibration and parameter adjustments, such as spectral calibration to account for room-specific factors for the media play back system. Examples of suitable room-specific calibration processes can be found in commonly owned U.S. Pat. No. 97,906,323, titled “Playback Device Calibration,” and U.S. Pat. No. 9,763,018, titled “Calibration of Audio Playback Devices,” each of which is hereby incorporated by reference in its entirety.

### c. Spatial Width Adjustments for Home Theatre Audio Playback

In some instances, using multichannel satellite playback devices can achieve a greater perceived width of audio playback, which can increase the immersiveness of the listening experience. Because multichannel satellite playback devices are capable of outputting audio along a plurality of sound axes, the perceived width of audio playback can be modified by selectively distributing playback between the multichannel satellite playback devices and a primary playback device (e.g., a soundbar). Additionally or alternatively, the perceived width of audio playback can be modified by selectively distributing playback between the various sound axes of the multichannel satellite playback devices. In some examples, the width of audio playback can be directly controlled by a user, or can be dynamically adjusted in response to certain detected parameters. Controlling the width of audio playback can help compensate for suboptimal placement of satellite playback devices (e.g., rear satellite playback devices too close together or too close to the listener, front satellite playback devices too closer to the primary playback device or too far apart, etc.).

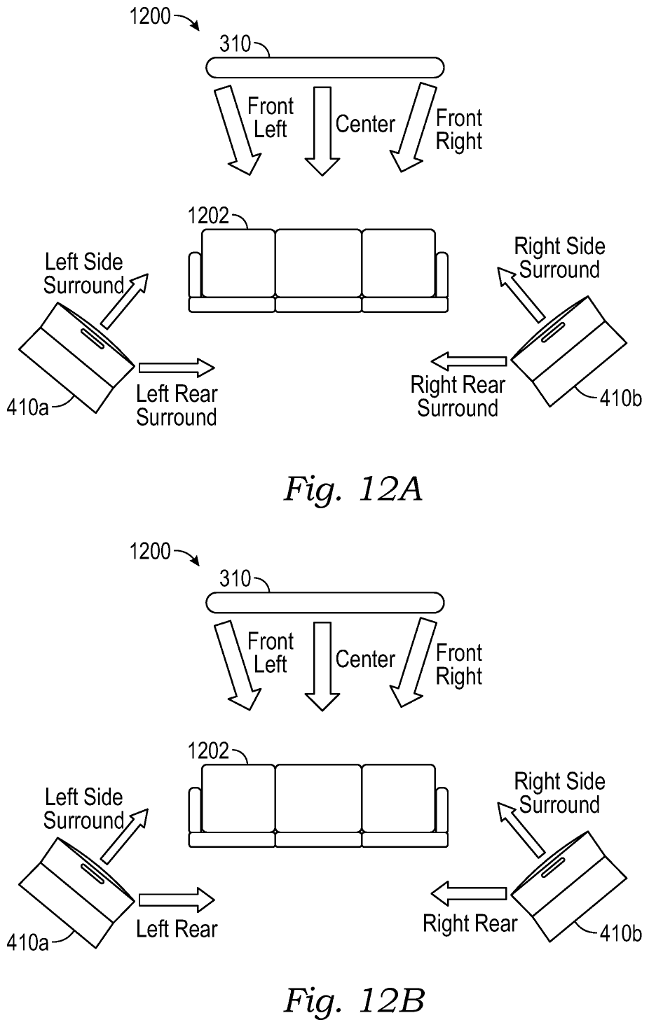

FIGS. 12A and 12B illustrate a home theatre environment including a media playback system 1200 arranged about an intended listening location 1202 (indicated as a couch). The media playback system 1200 includes a primary playback device 310 (e.g., a soundbar or other suitable playback device), a left rear satellite playback device 410a, and a right rear satellite playback device 410b. In this arrangement, playback responsibilities can be distributed among the various playback devices in a number of ways. In some examples, the primary playback device 310 can output at least center, front left, and front right channels, while the left rear satellite playback device 410a can output left side surround and left rear channels, and the right rear satellite playback device 410b can output right side and right rear channels. Optionally, the primary playback device 310 can also participate in outputting left and right side surround channels (e.g., via side-firing transducers of the primary playback device 310).

In various examples, the rear satellite playback devices 410 can be multichannel playback devices configured to output audio along a number of sound axes (e.g., a forward axis that propagates in a direction generally perpendicular to a front face of the play back device 410a, one or more side-firing axes that propagate at a lateral angle with respect to the forward axis, and optionally one or more up-firing axes that propagate at a vertical angle with respect to the forward axis.

By controlling the output of the various channels played back by the multichannel satellite playback devices 410, a perceived “width” of the combined audio output for a listener at the intended listening location 1202 can be modified. As noted above, controlling the perceived width of the combined audio output can help compensate for suboptimal placement of satellite playback devices. For instance, rear satellite playback devices that are placed too close together and/or too closer to the intended listening location 1202 may tend to reduce the perceived width or spaciousness of the combined audio output. Conversely, rear satellite play back devices that are placed too far apart and/or too far from the intended listening location 1202 may tend to increase the perceived width or spaciousness, which in some instances may be undesirable for the listener. In various examples, the perceived width can be modified by adjusting relative magnitudes of output of different channels of audio along different sound axes of the satellite playback devices.

For example, in the arrangement shown in FIG. 12A, the primary playback device 310 outputs center, front left, and front right audio channels which can generally be directed toward the intended listening location 1202. The left rear satellite playback device 410a outputs a left side surround channel along a first sound axis, and outputs a left rear channel along a second sound axis that can be laterally angled with respect to the first sound axis. In the illustrated configuration, the first sound axis is directed in a more forward direction, while the second sound axis is directed more laterally. The right rear satellite playback device 410b can be similarly configured to output a right side surround channel along a third sound axis and a right rear surround channel along a fourth sound axis.

In some examples, the perceived width of the combined audio output can be modulated by varying the relative magnitudes of the different audio channels being played back by the rear satellite playback devices 410a and 410b. For instance, as shown in FIG. 12B, the outputs of the rear satellite playback devices 410a and 410b can be modified (compared to the configuration shown in FIG. 12A) such that the left rear and right rear channels are played back at greater magnitudes, and the left side surround and right side surround channels are played back at lesser magnitudes (indicated by the relative sizes of the arrows). This adjustment can reduce a perceived width of the combined audio output compared to the arrangement shown in FIG. 12A, and may be appropriate when satellite playback devices 410a and 410b are spaced too far apart and/or too far from the intended listening location 1202. Conversely, to increase the perceived width, the left side surround and right side surround channels can be played back at greater magnitudes, and the left rear and right rear channels can be played back at lesser magnitudes. This may be appropriate when, for instance, the rear satellite playback devices 410a and 410b are spaced too close together and/or too close to the intended listening location 1202. In other words, by emphasizing side surround channels and de-emphasizing rear channels, the perceived width is increased, and conversely de-emphasizing side surround channels and emphasizing rear channels can reduce the perceived width.

Although FIGS. 12A and 12B illustrate varying relative magnitudes of the channels played back by the rear satellite playback devices 410a and 410b, in some examples a portion of the play back responsibilities can be moved from the rear satellite playback devices 410a and 410b to other playback devices. For instance, at least a portion of the side surround channels can be played back via the primary playback device 310 (or via other satellite playback devices) rather than via the rear satellite playback devices 410a and 410b, which can also affect the perceived width of the combined audio output.

In various examples, the media playback system 1200 can transition from the configuration shown in FIG. 12A to the configuration in FIG. 12B (or vice versa) based on one or more trigger conditions. Among examples, the trigger conditions can include a user input (e.g., user input via a controller device, voice input, etc.), detection of an environment acoustics parameter (e.g., based on a calibration process as described previously, detecting objects in the environment), a device position parameter (e.g., localization of a device, indication of device movement, etc.), a listener location parameter, and/or any other suitable conditions.

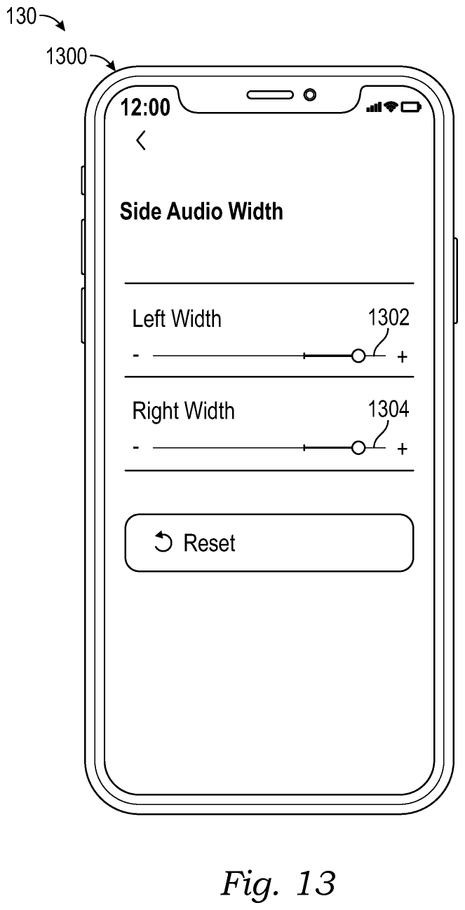

FIG. 13 illustrates an example interface 1300 for a control device 130 that enables a user to manually adjust a width parameter of audio playback. As shown, the interface 1300 can include a first slider 1302 for adjusting a left width (i.e., increasing or decreasing relative to an initial setting) and a second slider 1304 for adjusting a right width. Although separate sliders are shown for left and right widths, in some instances a single slider (or other input type) can simultaneously control the width of both left and right sides. Additionally or alternatively, separate sliders can be provided for modifying a rear width and a front width. In the case of adjusting a rear width (as described above with respect to FIGS. 12A and 12B), pushing the sliders 1302 and 1304 towards increased width can cause the side surround channels to be played back at greater magnitudes and the rear channels to be played back at lesser magnitudes.

While various examples described herein relate to adjusting a width of audio playback, a similar approach can be also be used to vary a perceived depth of audio playback (e.g., spaciousness along a forward-backward axis, rather than a left-right axis).

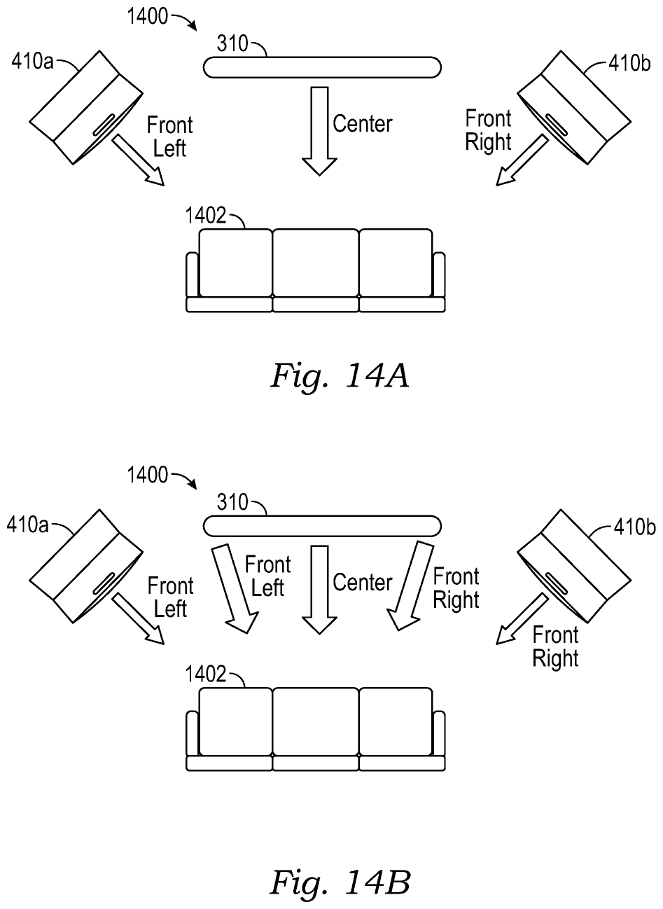

In addition or alternatively to adjusting a width of audio output by modifying play back responsibilities of rear satellite playback devices, the perceived width of audio output can also be modified by adjusting playback responsibilities of front satellite playback devices. FIGS. 14A and 14B illustrate a home theatre environment including a media play back system 1400 arranged about an intended listening location 1402 (indicated as a couch). The media playback system 1400 includes a primary playback device 310 (e.g., a soundbar or other suitable playback device), a left front satellite playback device 410a, and a right front satellite playback device 410b. In this arrangement, playback responsibilities can be distributed among the various playback devices in a number of ways. In some examples, the primary play back device 310 can output at least a center channel, while the left front satellite playback device 410a can output a front left channel and the right front satellite playback device 410b can output a front right channel. Optionally, the primary playback device 310 can also participate in outputting front left and front right channels.

As noted above, varying playback responsibilities of the individual playback devices within the media playback system can modify a perceived width of the combined audio output, and optionally can compensate for suboptimal placement of the satellite playback devices relative to an intended listening location. With respect to front satellite playback devices 410a and 410b, the width can be increased by playing back a greater proportion of the front left and front right audio channels via the front satellite playback devices 410a and 410b, and conversely the width can be decreased by playing back a lesser proportion of the front left and front right audio channels via the front satellite playback devices 410a and 410b (e.g., and playing back an increased proportion of the front left and front right audio channels via the primary playback device 310).

For instance, as shown in FIG. 14A, in a first arrangement the media playback system 1400 can play back a front left channel via only the front left satellite playback device 410a, and can also play back a front right channel via only the front right satellite playback device 410b. In this example, the primary playback device 310 outputs a center audio channel and does not output front left or front right audio channels. In contrast, in the arrangement shown in FIG. 14B, a width of the combined audio output is reduced (relative to the arrangement of FIG. 14A) by routing at least some of the front left and front right audio channels through the primary playback device 310, and/or playing back a lesser proportion of the front left and front right channels via the front left and front right satellite playback devices 410a and 410b, respectively.

In various examples, the media playback system 1400 can transition between the arrangement shown in FIG. 14A and that shown in FIG. 14B (and vice versa) based on one or more trigger conditions. As noted above, the trigger indications or conditions can include a user input (e.g., user input via a controller device as shown in FIG. 13, via voice input, etc.), detection of an environment acoustics parameter, a device position parameter, a listener location parameter, and/or any other suitable conditions.

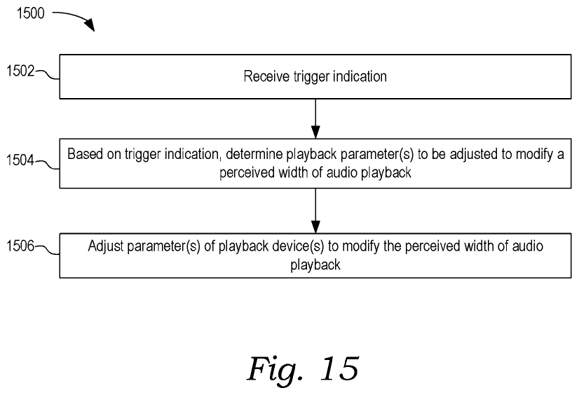

FIG. 15 is a block diagram of a method 1500 for modifying a width parameter of audio playback. The method 1500 begins in block 1502 with receiving a trigger indication. As noted previously, the trigger indication can take any suitable form, including direct user input (manual input, voice controlled, etc.), and/or the system can automatically detect certain conditions (e.g., acoustic conditions of the environment, location or movement of device(s) or listener(s), etc.).

In block 1504, based on the trigger indication, playback parameter(s) to be adjusted to modify a perceived width of audio playback are determined. And at block 1506, the method 1500 involves adjusting parameter(s) of one or more playback devices to modify the perceived width of audio playback. The playback parameter(s) can include relative magnitudes of one or more channels of audio playback, and/or varying playback responsibilities for particular devices (e.g., varying which device(s) are responsible for playing back particular audio channels). As noted above, this can involve increasing or decreasing a relative magnitude of playback of certain channels by certain playback devices (e.g., increasing a side surround channel magnitude and decreasing a rear surround channel magnitude for a rear satellite playback device). Additionally or alternatively, this can involve modifying which playback devices participate in playing back particular channels (e.g., routing front left and front right audio channels through the primary playback device in response to the trigger indication).

### d. Modifying Playback Parameters to Compensate for Satellite Playback Device Placement

In some cases, a user's placement of multichannel satellite playback devices around her environment may differ from the intended placement, either in terms of device location or device orientation. As a result, the audio output by the multichannel satellite playback devices can have unintended properties, such as a side surround channel being directed too far forward or too far rearward of an intended listening location. Examples of the present technology can address these and other problems by modifying playback parameters of multichannel satellite playback devices to compensate for their placement within the environment. As a result, even when a user places multichannel audio satellite playback devices in undesirable locations or orientations, the system can adapt play back to provide an improved listening experience.

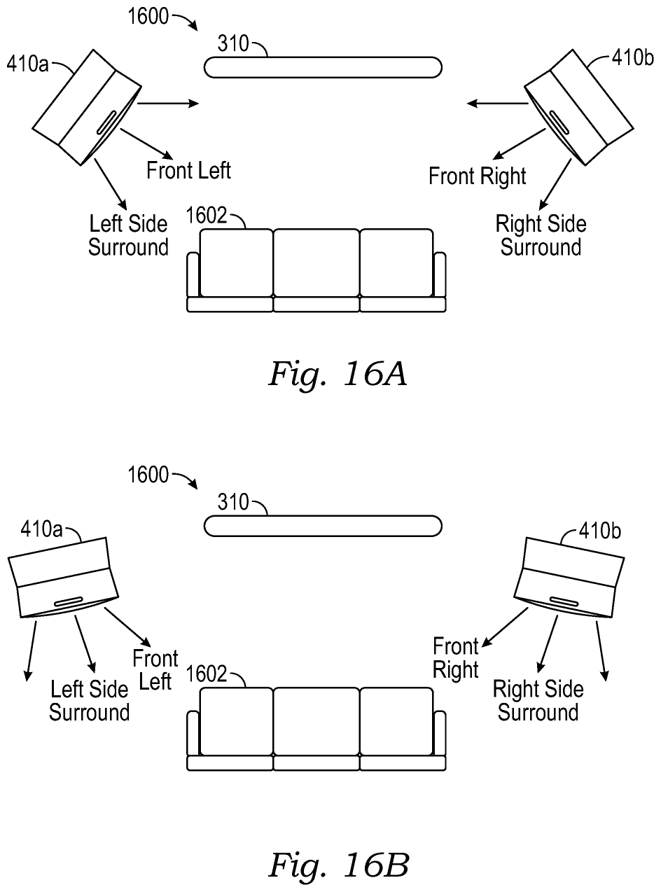

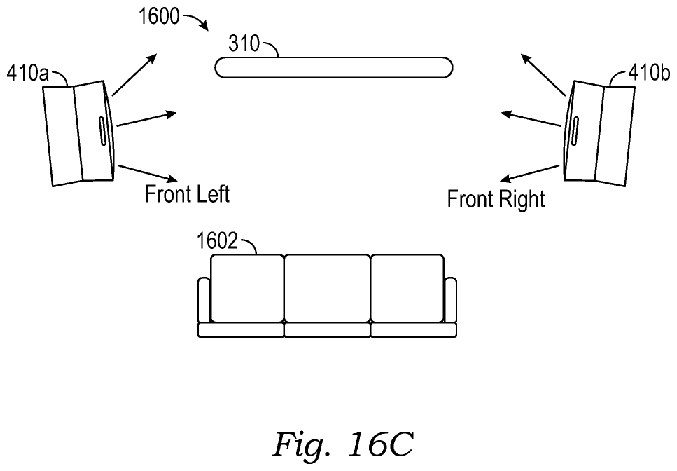

FIGS. 16A-16C illustrate a home theatre environment in which a media play back system 1600 is arranged about an intended listening location 1602 (shown as a couch). The media playback system 1600 can include a primary playback device 310 (e.g., a soundbar), a front left satellite playback device 410a, and a front right satellite playback device 410b. As illustrated, the satellite playback devices 410a and 410b can each be configured to output audio along a plurality of sound axes, which can be laterally angled with respect to one another. These can include, for example, a forward-firing axis that extends substantially perpendicular to a front face of the play back device 410, and left and right side-firing axes that are angled laterally on opposing sides of the forward-firing axis. Due to the arrangement of individual transducers within the satellite playback device 410, audio output can be directed along one or more sound axes to achieve a desired acoustic effect. In some instances, a single audio channel can be mapped to a particular sound axis, while in other instances a single audio channel can be output via two or more sound axes, and moreover two or more audio channels can be output via the same sound axis.

For example, in the arrangement shown in FIG. 16A, the front left satellite playback device 410a outputs a front left channel along its forward-firing axis, and outputs a left side surround channel via its right side-firing axis, while the front right satellite playback device 410b outputs a front right channel along its forward-firing axis, and outputs a right side surround channel via its left side-firing axis. In the illustrated example, this configuration results in the front right and front left audio channels propagating essentially directly toward the listening location 1602, while the left side surround and right side surround channels are directed to locations laterally spaced away from the listening location 1602. While this playback configuration may achieve the desired results in terms of spaciousness and/or immersiveness, the acoustic performance can depend significantly on the particular location and/or orientation of the satellite playback devices 410. For instance, if these devices 410a are oriented differently (e.g., rotationally adjusted either forward or backward relative to the arrangement shown in FIG. 16A), the audio output channels may propagate along undesirable directions.

To compensate for the variations in placement and orientation by users in the environment, the media playback system 1600 can obtain an indication of device orientation(s) for the satellite play back devices 410a and/or 410b, and can modify playback responsibilities for these devices accordingly. In various examples, obtaining an indication of device orientations can involve sensing an orientation of the playback devices 410 via on-board sensors (e.g., accelerometers, gyroscopes, magnetometers, etc.), by analyzing acoustic output of the devices 410, using other sensors not associated with the playback devices 410, or any other suitable technique. In various examples, the orientation of the playback device can be determined by the playback device itself, or can be determined via other devices and the indication can be transmitted to the playback device or other device of the media playback system. The orientation can include, for example, an angular orientation of the device (e.g., rotation about a vertical axis extending through the playback device 410) relative to the environment, relative to a listener, and/or relative to other playback devices. In some examples, the orientation can also include position (e.g., absolute position, distance between the play back device 410 and the listening location, other devices within the environment, a height of the playback device 410 relative to the environment, etc.).

In some implementations, based on obtaining orientation information for one or more playback devices 410, the playback responsibilities for those device(s) can be modified. For instance, in the arrangement shown in FIG. 16B, the satellite playback devices 410a and 410b are rotated rearward (relative to the orientation shown in FIG. 16A) such that the forward-firing axes of these devices are no longer aimed toward the listening location 1602. To compensate for this position, playback responsibilities can be modified such that, as shown in FIG. 16B, the front left channel is output along a left side-firing axis of the left front satellite play back device 410a, and the front right channel is output along a right side-firing axis of the right front satellite playback device 410b. Although the front right and front left channels are output via side-firing axes, because the angular orientations of the playback devices 410 has shifted relative to that shown in FIG. 16A, the front right and front left channels are nonetheless output in a more advantageous direction (e.g., generally aimed directly toward the listening location 1602). As also shown in FIG. 16B, the left side surround channel can be output via the forward-firing axis of the front left satellite playback device 410a, and the right side surround channel can be output via the forward-firing axis of the front right satellite playback device 410b.

FIG. 16C illustrates another arrangement of the media playback system 1600. In this configuration, the front satellite playback devices 410 are rotated forward (relative to the orientation shown in FIG. 16A), such that such that the forward-firing axes of these devices are no longer aimed toward the listening location 1602. To compensate for this position, playback responsibilities can be modified such that, as shown in FIG. 16C, the front left channel is output along a right side-firing axis of the left front satellite playback device 410a, and the front right channel is output along a left side-firing axis of the right front satellite playback device 410b. Although the front right and front left channels are output via side-firing axes, because the angular orientations of the playback devices 410 has shifted relative to that shown in FIG. 16A, the front right and front left channels are nonetheless output in a more advantageous direction (e.g., generally aimed directly toward the listening location 1602). Accordingly, because the satellite playback devices 410 can output audio along a plurality of sound axes, playback responsibilities can be dynamically modified to direct particular audio channels along intended directions relative to a listener, even when devices are placed in suboptimal or unexpected configurations, positions, or orientations.

Although FIGS. 16A-16C illustrate each audio channel being output only along one sound axis or another, in various examples similar adjustments can be made in which relative proportions of the audio channel output along various axes are modified. For instance, in a first configuration, a front left channel can be output primarily along a forward-firing axis and secondarily along a side-firing axis, and in a second configuration the front left channel can be output primarily along the side-firing axis and secondarily along the forward-firing axis. That is, the magnitude of output of the front left channel along the forward-firing axis can be reduced, and the magnitude of output of the front left channel via the side-firing axis can be increased. This approach can be extended to any number of audio channels, sound axes, and/or satellite playback devices.

While the examples shown in FIGS. 16A-16C relate to front satellite playback devices, the same approach can be taken to other satellite playback devices, whether they are positioned as side satellite playback devices, rear satellite playback devices, or otherwise. Moreover, while the illustrated examples show different rotational orientations at constant positions, in various implementations the playback devices can have different locations and/or rotational orientations with respect to the listening environment, and the playback responsibilities for the particular devices (and the particular drivers within those devices) can be varied to achieve the desired psychoacoustic effects given the particular placement and/or orientation of the play back device(s).

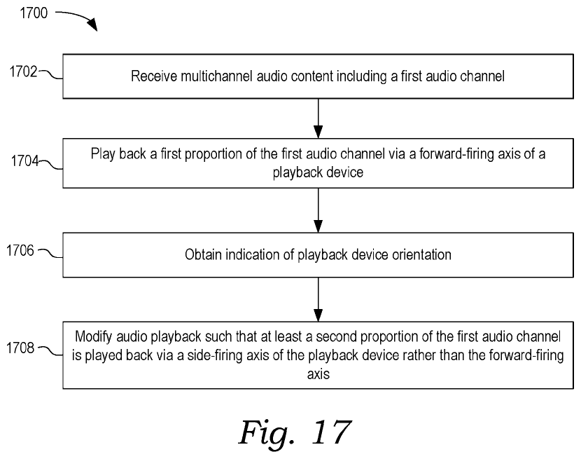

FIG. 17 is a block diagram of a method 1700 for modifying playback parameters to compensate for satellite playback device placement. The method 1700 begins at block 1702 with receiving multichannel audio content including a first audio channel. The multichannel audio content can be received at, for example, a discrete satellite playback device in a home theatre zone or other suitable playback device.

At block 1704, the method 1700 involves playing back a first proportion of the first audio channel via a forward-firing axis of the playback device. The method 1700 continues in block 1706 with obtaining an indication of playback device orientation. As noted previously, this can involve sensing an orientation of the playback device via on-board sensors, by analyzing acoustic output of the device, using other sensors not associated with the play back device, or any other suitable technique. In various examples, the orientation of the play back device can be determined by the playback device itself, or can be determined via other devices and the indication can be transmitted to the playback device or other device of the media playback system.

In some examples, the orientation indication can reflect the degree to which the forward-firing axis is oriented with (e.g., aligned with, aimed toward, etc.) the intended listening location. For instance, if the playback device is rotated such that a side-firing axis is oriented nearer to the intended listening location than the forward-firing axis, then playback responsibilities can be modified to compensate.

At block 1708, audio playback via the playback device is modified such that at least a second proportion of the first audio channel is played back via a side-firing axis of the playback device rather than the forward-firing axis. For example, in the case of a front right satellite playback device, a front right audio channel may first be output along a forward-firing axis, but then, based on the indication of playback device orientation, the front right audio channel may instead be output at least in part along a side-firing axis. This can compensate for a suboptimal orientation of the play back device relative to the intended listening location.

In some examples, when the playback device plays back the first proportion of the first audio channel via the forward-firing axis, the playback device plays back none of the first audio channel via the side-firing axis. Additionally or alternatively, when the playback device plays back at least the second proportion of the first audio channel via the side-firing axis, the playback device plays back none of the first audio channel via the forward-firing axis.

In some implementations, while the playback device plays back at least the first proportion of the first audio channel via the forward-firing axis, the playback device can also play back a third proportion of the first audio channel via the side-firing axis (e.g., with the first audio channel being played back primarily but not exclusively by the forward-firing axis). Then, while the play back device plays back at least the second portion of the first audio channel via the side-firing axis (based on the indication of playback device orientation), the play back device also plays back a fourth proportion of the first audio channel via the forward-firing axis, wherein the first proportion is greater than the fourth proportion, and the second proportion is greater than the third proportion. In other words, following the indication of play back device orientation, the first audio channel can be output to a smaller degree along the forward-firing axis, and to a greater degree along the side-firing axis.

### IV. EXAMPLE METHODS FOR IMPROVING DIRECTIVITY IN AUDIO OUTPUT

As noted previously, in some instances audio playback devices can be configured to play back multichannel audio content that includes vertical content (e.g., audio content configured to be played back via ceiling-mounted or up-firing transducers so that a listener localizes the sound as originating from overhead). Examples of vertical content include height channels such as front right height, front left height, rear right height, rear left height, etc. While such vertical content can be played back at least in part via up-firing transducers that are configured to direct audio output in an upward direction, there may nonetheless be forward “leakage” in which a portion of this vertical content propagates horizontally (e.g., in the forward direction). This forward leakage reduces the directivity of the vertical content output via the play back device, such that the vertical content may no longer be perceived as originating from a position overhead, thereby reducing immersiveness of the audio and diminishing the listening experience.

Examples of the disclosed technology may address these and other shortcomings by outputting a “null signal” that is configured to at least partially cancel out the undesirable leakage of vertical content along the forward (or other lateral) direction. For instance, as described in more detail below, by outputting vertical channel content via an up-firing transducer (or array) concurrently with outputting a null signal via a forward-firing transducer (or array) that destructively interferes with the vertical content along the forward sound axis, the amount of vertical content that reaches a listener along the forward sound axis can be reduced.

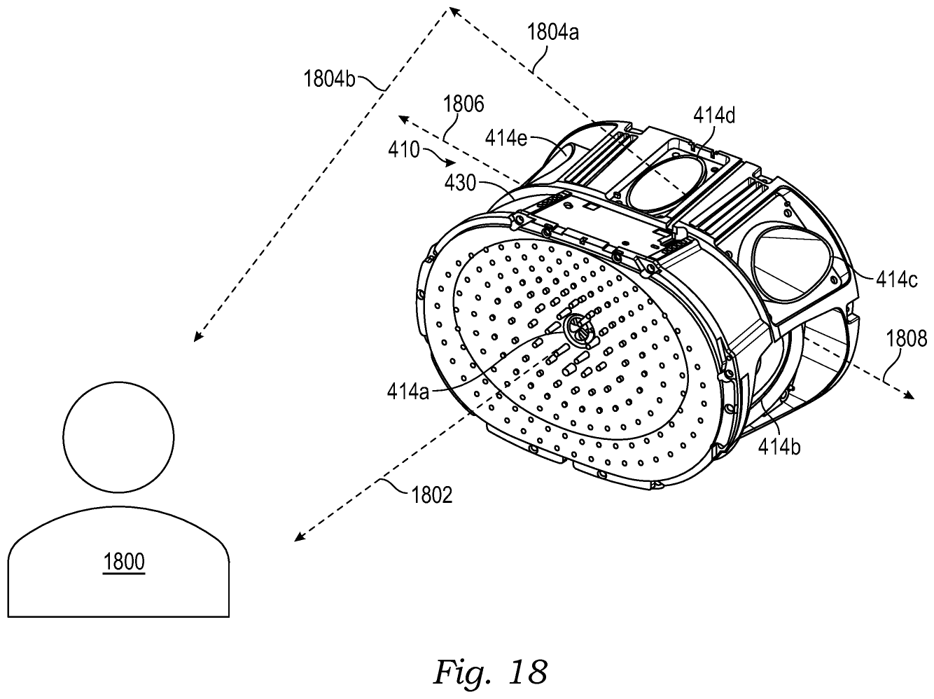

FIG. 18 schematically illustrates exemplary play back of multichannel vertical audio content via the playback device 410 towards a user 1700. In various examples, the playback device 410 can be used as a satellite playback device for a home theatre arrangement, for instance being assigned playback responsibilities as a rear right surround, rear left surround, front right surround, front left surround, or any other suitable configuration. In many such instances, an identical playback device can be placed in a mirrored configuration (e.g., with playback device 410 as a rear left surround and a second identical playback device serving as a rear right surround). In such cases, the principles discussed here may be similarly applied, mutatis mutandis, to the corresponding second playback device in the mirrored position.

As shown in FIG. 18, the playback device 410 may output forward-propagating audio 1802, which is oriented along the forward sound axis 460 (FIG. 4D). This audio can be exclusively or primarily output by the transducer 414a, and in operation the playback device 410 can be positioned about a room such that this forward-propagating audio 1802 is directed substantially directly toward the user 1800 (or an intended listening position within a room or environment). The up-firing transducer 414d can output upward-propagating audio 1804a, which is directed towards an acoustically reflective surface (e.g., a ceiling) and reflected towards the user 1800 as audio 1804b. Because of the reflected path of audio 1804b, the user 1800 may perceive the audio 1804b as originating from overhead, which is desirable for vertical audio content. The upward-propagating audio 1804a can be directed primarily along the vertical sound axis 470 (FIG. 4D), which can be vertically angled with respect to the forward sound axis (e.g., by between about 180 degrees and about 90 degrees, between about 60 degrees and about 80 degrees, or about 70 degrees).

With continued reference to FIG. 18, the playback device 410 can also output left side-propagating audio 1806 which is directed along the left side sound axis 480 (FIG. 4D). As noted above, this left side sound axis can be horizontally angled with respect to the forward sound axis (aligned with the direction of forward-propagating audio 1802), for example by about 90 degrees. In the illustrated example, this side-propagating audio 1806 can be output via an array including two transducers: side-firing transducer 414e and side-firing transducer 414f (not shown in FIG. 18; best seen in FIG. 4C). In the illustrated example, the first side-firing transducer 414e can be a tweeter while the second side-firing transducer 414f can be a woofer, though other configurations are possible. In various instances, any particular transducer can be substituted by an array of suitable transducers, and conversely an array of transducers can be substituted by a single appropriately configured transducer. A similar arrangement of side-firing transducers 414b and 414c can cooperate to output right side-propagating audio 1808 which is directed along the right side sound axis 490 (FIG. 4D). This right sound axis can be horizontally angled with respect to the forward sound axis (aligned with the direction of forward-propagating audio 1802), for example by about 90 degrees, and by about 180 degrees from the left sound axis.

In operation, multichannel audio content played back via the playback device 410 can be output via one or more of the illustrated directions depending on the particular content and configuration of the playback device. In some examples, the playback device 410 can be configured as a rear satellite playback device (e.g., rear left satellite device), in which left rear surround audio content is played back via the first transducer 414a and is directed as forward-propagating audio 1802. Meanwhile, vertical audio content (e.g., left height channel) is played back via the up-firing transducer 414d and is directed as upward-propagating audio 1804a to be reflected towards the user 1800 as reflected audio 1804b. In some implementations, vertical audio content (e.g., left height channel) is played back via an array that includes the up-firing transducer 414d (output as upward-propagating audio 1804a) in conjunction with side-firing transducers 414e, 414f, and 414b such that at least a portion of the vertical content is also output via these side-firing transducers. The addition of these side-firing transducers can enhance the total output of vertical content (e.g., by utilizing additional transducers, and particularly those with more bass capability such as transducers 414f and 414b). However, whether using only a single up-firing transducer 414d for the output of vertical content, or when using an array of transducers (including the up-firing transducer 414d) for the output of vertical content, a portion of the vertical content may “leak” along the forward sound axis 460 (FIG. 4D; aligned with the direction of forward-propagating audio 1802).

To reduce this forward leakage of vertical content, the audio content can be modified to introduce a null signal to be output via at least the forward-firing transducer 414a as forward-propagating audio 1802. This null signal can be configured to offset, cancel, or otherwise reduce the perception of vertical content propagating along the forward sound axis. For instance, the null signal output via the forward-firing transducer 414a can be configured to destructively interfere with vertical content played back via the other transducers 414, at least along the forward sound axis. In this configuration, the forward-firing transducer 414a can output the null signal in combination with its other playback responsibilities (e.g., playback of left rear surround channel content).

In some examples, the null signal can be generated by phase-shifting the vertical content signal and synchronizing the output such that the null signal destructively interferes with the vertical content output along the forward sound axis. In various examples, the null signal can be output via one or more horizontally oriented transducers, which can include forward-firing, side-firing, or other suitable transducers or combinations thereof.

As a result of canceling out at least a portion of the vertical content that propagates along the forward axis, the user 1800 is more likely to localize the vertical content as originating from the point on the ceiling from which the up-firing output has reflected (e.g., along the path of reflected audio 1804b). In some instances, the user's localization can be based on perceiving vertical content both from the ceiling reflections and from forward leakage (e.g., propagating directly horizontally as forward-propagating audio 1802). While use of the null signal can reduce the magnitude of forward leakage, when some forward leakage remains the user 1800 may localize vertical content as originating from a point somewhere between (1) the vertical reflection point on the ceiling, and (2) the position of the up-firing transducer 414d (or other transducers of the playback device 410). In some implementations, it may be desirable to retain at least some forward leakage, such that by controlling the configuration and magnitude of the null signal, the perceived origination point can be selected to achieve the desired psychoacoustic effects (e.g., localizing vertical content at desired positions relative to an intended listening location). This may be the case when, for instance, the listening environment has especially high ceilings, unusual reflective properties, or any other conditions that lead to the acoustic reflection point being misaligned with the desired perceived origination point for the vertical content.

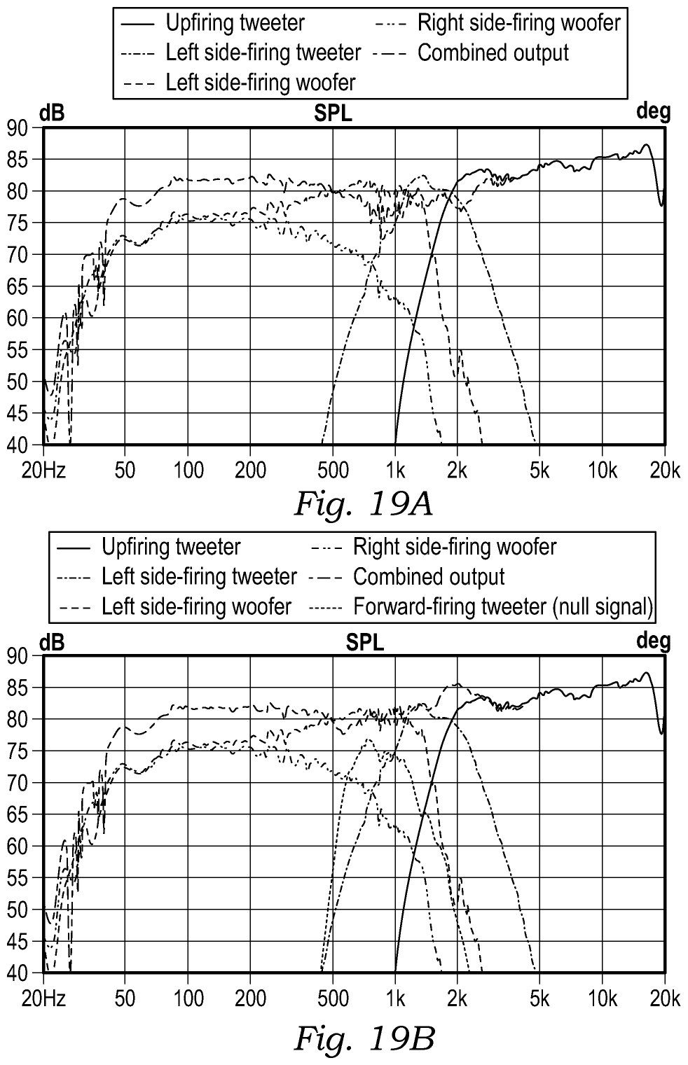

FIGS. 19A and 19B are graphs illustrating audio output contributions from various transducers in accordance with examples of the disclosed technology. In particular, FIG. 19A illustrates audio output via the various individual transducers of the playback device 410 during play back of left vertical channel content. In FIG. 19A, the various transducers participating in playback include an up-firing tweeter (e.g., up-firing transducer 414d shown in FIGS. 4A-4D and FIG. 18), a left side-firing tweeter (e.g., side-firing transducer 414e), a left side-firing woofer (e.g., transducer 414f), and a right side-firing woofer (e.g., transducer 414b). In FIG. 19B, a similar plot is shown, now with the addition of a null signal output via a forward-firing tweeter (e.g., forward-firing transducer 414a). In operation, as noted previously, this null signal can serve to at least partially cancel (e.g., destructively interfere with) vertical content propagating along a forward sound axis from the playback device.

Because forward leakage can be more pronounced and/or more perceptible in certain frequency ranges, the null signal may be restricted to a particular frequency range. In the illustrated example, the null signal extends between approximately 500 Hz to approximately 2.5 kHz, though other frequency bands are possible. In general, the null signal can be restricted to a particular frequency range, for instance having a predetermined lower threshold frequency, upper threshold frequency, and bandwidth. In various examples, the null signal can have a bandwidth that is less than about 5.0 kHz, 4.5 kHz, 4.0 kHz, 3.5 kHz, 3.0 kHz, 2.5 kHz, 2.0 kHz, 1.5 kHz, 1.0 kHz, or 0.5 kHz. In some examples, the null signal can have a bandwidth that is greater than about 0.5 kHz, 1.0 kHz, 1.5 kHz, 2.0 kHz, 2.5 kHz, 3.0 kHz, 3.5 kHz, 4.0 kHz, 4.5 kHz, or 5.0 kHz. The lower frequency threshold may vary in different implementations, for example being equal to or greater than about greater than about 200 Hz, 300 Hz, 400 Hz, 500 Hz, 600 Hz, 700 Hz, 800 Hz, 900 Hz, or 1 kHz. Similarly, the upper frequency threshold may vary in different implementations, for example being equal to or lesser than about 1.0 kHz, 1.5 kHz, 2.0 kHz, 2.5 kHz, 3.0 kHz, 3.5 kHz, or 4.0 kHz, for instance between about 500 Hz to about 2.5 kHz, or any suitable frequency range for a given application and configuration of playback devices.

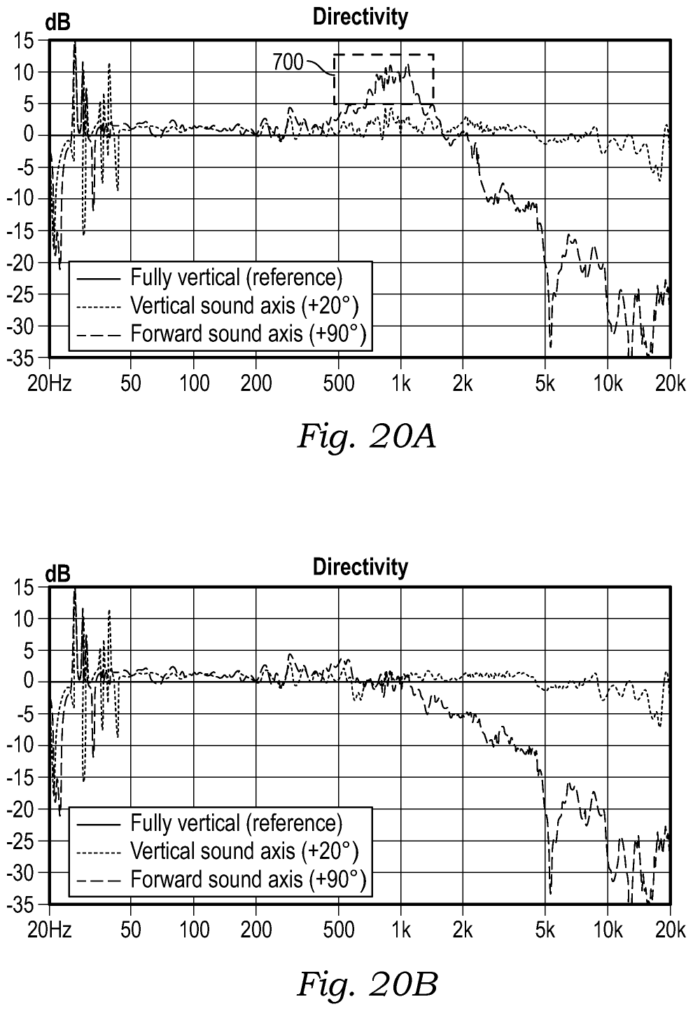

FIGS. 20A and 20B are graphs illustrating directivity of left height channel audio output as measured along different sound axes. In particular, sound pressure level (SPL) values measured during left height channel audio output is shown, with SPL values normalized to measurements taken along the fully vertical position (the 0 degree vertical position). The vertical sound axis line reflects SPL values measured along the vertical sound axis (e.g., vertical sound axis 470 shown in FIG. 4D), and the forward sound axis reflects SPL values measured along the forward sound axis (e.g., forward sound axis 460 shown in FIG. 4D). In FIG. 20A, the audio is output according to the configuration of transducers shown in FIG. 19A, while in FIG. 20B the audio is output according to the configuration shown in FIG. 19B (i.e., with the addition of the null signal being output via a forward-firing tweeter).

As seen in FIG. 20A, the SPL of the audio output along the forward axis has a peak (indicated by box 700) between approximately 500 Hz and 1.5 kHz, indicating a significant amount of forward leakage of this left height channel audio content along the forward sound axis. As depicted in FIG. 20B, when the null signal is added to the combined output this peak is significantly reduced, and in fact the SPL along the forward sound axis is lower than the SPL along the vertical sound axis, particularly for frequencies above 1 kHz.

Accordingly, as a result of the null signal, the SPL values of the vertical content that propagates along the forward axis can be significantly lower than the SPL of the vertical content that propagates along the vertical axis when measured at similar distances from the play back device (e.g., measured at 1 foot, 3 feet, 5 feet, etc. from the playback device along their respective sound axes). In some examples, the SPL of the vertical content propagating along the forward axis can be at least 1 dB, 2 dB, 3 dB, 4 dB, 5 dB, 6 dB, 7 dB, 8 dB, 9 dB, 10 dB, 15 dB, or 20 dB less than the SPL of the vertical content that propagates along the up-firing axis measured at similar distances from the playback device and at a particular reference frequency (e.g., 500 Hz, 1 kHz, 1.5 kHz, 2.0 kHz, etc.).

To ensure that the null signal played back via the forward-firing transducer is aligned with the vertical content played back via the up-firing transducer (and optionally via one or more side-firing transducers), the null signal can be time delayed (or advanced) with respect to the output of the vertical content via the up-firing transducer or array. This time shift can be configured to compensate for the different path length that the null signal takes to reach the listener (e.g., propagating from the forward-firing transducer) as compared to the vertical content (e.g. propagating from the up-firing transducer or array).

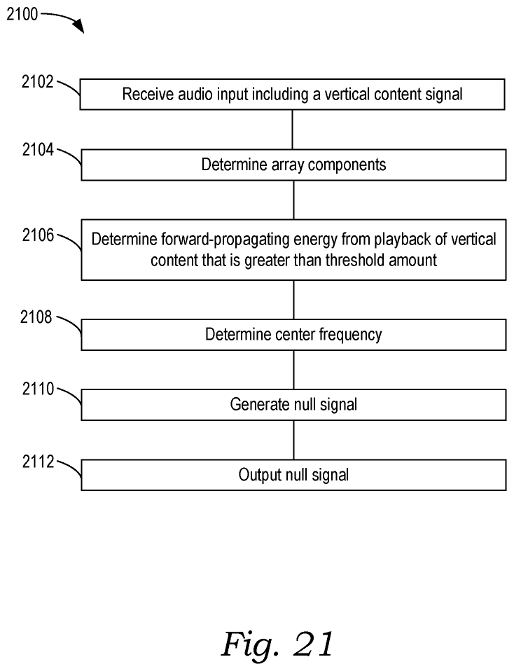

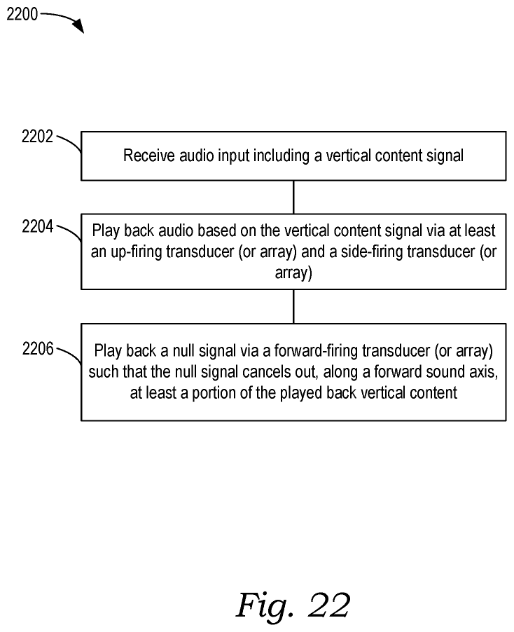

FIGS. 21 and 22 are flow diagrams of methods 2100, 2200 for playing back audio in accordance with examples of the disclosed technology. The processes described herein can be implemented by any of the devices described herein, or any other devices now known or later developed. Various embodiments of the methods described herein include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the methods described below, and for other processes and methods disclosed herein, the flowcharts show functionality and operation of possible implementations of some embodiments. In this regard, each block may represent a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that stores data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 21 and 22 may represent circuitry that is wired to perform the specific logical functions in the process.

FIG. 21 illustrates an example method 2100 for playing back audio content including a null signal. The method 2100 begins in block 2102 with receiving, at a play back device, audio input including a vertical content signal. The audio input can include any suitable audio format that includes a vertical component, such as DOLBY ATMOS, MPEG-H, DTS:X, or any other suitable 3D or other immersive audio format. The audio input can be full-channel audio input (e.g., containing all audio to be played back by the media playback system including the playback device) or can only be a subset of the multichannel audio content (e.g., containing only select channels to be played back by the particular playback device, concurrently with additional playback devices within the media play back system).

In block 2104, the method 2100 involves determining array components for audio playback. For instance, based on the received audio input, suitable output arrays can be configured such that, for a given channel of audio content, one or more transducers participate in its playback. Accordingly, any given transducer may participate in multiple different arrays simultaneously, and the output of audio via that particular transducer is a superposition of the various arrays in which it participates. For instance, in the case of a rear satellite playback device playing back a left height channel, audio may be output via each of an up-firing transducer, a left side-firing tweeter, a left side-firing woofer, and a right side-firing woofer (as in the example described above with respect to FIGS. 19A and 19B). Any one of these transducers that participates in playback of the left height channel array may also participate in other arrays to output other channels (e.g., a left rear surround channel).

In block 2106, the method 2100 optionally includes determining a forward-propagating energy from playback of vertical content that is greater than a threshold amount. For instance, given particular audio content to be played back via a left height channel, a model of audio output can be used to predict an amount of forward-propagating energy that would result from playback of that audio via the particular array of transducers identified in block 2104. Additionally or alternatively, a microphone (e.g., carried by a control device, another playback device in the room, a network microphone device, or any other suitable device) positioned appropriately within the environment may capture sound data indicative of the amount of forward-propagating energy during playback of the vertical content.

The amount of forward-propagating energy may be influenced by the volume of audio playback, the frequency characteristics of the audio (e.g., amount of low-frequency content, mid-frequency content, and high-frequency content), or other aspects of the audio input. If the predicted amount of forward-propagating energy exceeds a predetermined threshold (e.g., indicating that forward-leakage of vertical content exceeds a predetermined acceptable level), this may indicate the need for a compensatory null signal to be output via the playback device to increase directivity of play back of the vertical content.

The method 2100 can also optionally include, in block 2108, determining a center frequency (or frequencies) corresponding to the undesirable forward-propagating energy. This center frequency can be extracted from the predicted or measured forward-propagating energy in block 2106. The center frequency can reflect a frequency of highest forward-propagating energy, or a weighted average of forward-propagating energy over a given frequency range to identify a center frequency.

In block 2110, the null signal can be generated. Optionally the null signal can be generated in response to a determination in block 2106 that the forward-propagating energy exceeds a predetermined threshold. Alternatively, the null signal can be generated in every case, regardless of any measured or predicted amount of forward leakage. Additionally, the null signal can be generated based at least in part on the determined center frequency in block 808, for instance with the null signal having a frequency response curve that is centered on the center frequency. Alternatively, the null signal can be generated without reference to any determination of a center frequency of the forward-propagating energy.

As noted previously, in some instances the null signal can be generated by phase-shifting the vertical content (e.g., the left height channel) by 180 degrees such that when the null signal is played back via one or more first transducers (e.g., along a forward sound axis of the playback device), the null signal destructively interferes with the vertical content being played back by one or more second transducers (e.g., an up-firing transducer or array playing back audio along a vertical axis).

In block 2112, the method 2100 involves playing back the null signal. In the case of a null signal configured to reduce horizontal leakage of vertical content, the null signal may be played back by one or more transducers oriented horizontally. The null signal will interfere most strongly along the axis of its output, accordingly the null signal may be played back exclusively or primarily along the axis of unintended leakage, such as the forward sound axis or another horizontal sound axis of the playback device. In operation, playing back the null signal along the forward sound axis while the vertical content is played back along the vertical sound axis will reduce the amount of forward leakage of the vertical content along the forward sound axis. The net result is improved directivity of the vertical content and enhanced immersiveness for the listener.

FIG. 22 illustrates another example method 2200 for playing back audio content including a null signal. The method 2200 begins in block 2202 with receiving, at a playback device, audio input including a vertical content signal. The audio input can include any suitable audio format that includes a vertical component, such as DOLBY ATMOS, MPEG-H, DTS:X, or any other suitable 3D or other immersive audio format.

In block 2204, the method 2200 involves playing back audio based on the vertical content signal via at least an up-firing transducer (or array of transducers that includes at least one up-firing transducer) and a side-firing transducer (or array of transducers that includes at least one side-firing transducer). Optionally, the vertical content is played back only via the up-firing transducer or array, and horizontally oriented transducers do not contribute to the playback of the vertical content.

The method 2200 continues in block 2206 with playing back a null signal via a forward-firing transducer (or array of transducers including a forward-firing transducer) such that the null signal cancels out, along a forward sound axis, at least a portion of the vertical content being played back via the up-firing transducer (or array) and the side-firing transducer (or array). This null signal can be played back concurrently with playback of the vertical content via the up-firing transducer or array. As described previously, this null signal can destructively interfere with the vertical content primarily along the forward axis (or other horizontal axis) without significantly affecting the output along the vertical sound axis. In some implementations, to achieve destructive interference, output of the null signal can be time-delayed (or advanced) relative to the vertical content to account for the spatial separation between the transducer(s) outputting the null signal and the transducer(s) outputting the vertical content.

Although several examples described herein relate to the use of a null signal directed along a forward axis to offset forward leakage of vertical content, various other implementations are also contemplated. For example, a null signal can be output via one or more side-firing transducers (with or without concurrent output via a forward-firing transducer) concurrently with output of vertical content via an up-firing transducer to prevent lateral horizontal “leakage”. Similarly, a null signal can be used to improve directivity within the horizontal plane. For example, while a forward-firing transducer outputs first content (e.g., left surround), a null signal can be output via one or more side-firing transducers or arrays (on one or both lateral sides of the playback device) to reduce horizontal “leakage” of the forward-firing transducer output and increase its directivity. In various examples, a null signal can be output via any transducer or combination of transducers along a sound axis in a manner that destructively interferes with an output signal of other transducer(s) along that sound axis.

According to some implementations, a given playback device can be configured to output a first null signal via a first transducer (or array) while in a first playback mode, and to output a second null signal via a second transducer (or array) while in a second playback mode. For example, while in a first playback mode as a satellite playback device for a home theatre arrangement, the playback device can output a vertical-content null signal via a forward-firing transducer (thereby reducing vertical content along the forward sound axes). If the playback device is then transitioned from the first mode to a second mode (e.g., by being removed from the home theatre group and instead being bonded into a stereo pair with another playback device), the playback device may instead play back the null signal via a different transducer or array of transducers. In one example, if the playback device is arranged in a stereo pair, the vertical-content null signal may instead be played back via side-firing transducers (on one or both sides) rather than via the forward-firing transducer. In still other examples, different null signals can be used in different configurations, for instance in some modes the null signal can be configured to reduce forward leakage of vertical content, while in another mode the null signal can be configured to reduce lateral leakage of side-directed or forward-directed content.

### VI. CONCLUSION

The above discussions relating to play back devices, controller devices, playback zone configurations, and media content sources provide only some examples of operating environments within which functions and methods described below may be implemented. Other operating environments and/or configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software examples or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “example” means that a particular feature, structure, or characteristic described in connection with the example can be included in at least one example example of an invention. The appearances of this phrase in various places in the specification are not necessarily all referring to the same example, nor are separate or alternative examples mutually exclusive of other examples. As such, the examples described herein, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring examples of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. EXAMPLES

The disclosed technology is illustrated, for example, according to various examples described below. Various examples of examples of the disclosed technology are described as numbered examples for convenience. These are provided as examples and do not limit the disclosed technology. It is noted that any of the dependent examples may be combined in any combination, and placed into a respective independent example. The other examples can be presented in a similar manner.

Example 1: A media playback system comprising: a primary playback device; a satellite playback device; one or more processors; a network interface; and data storage having instructions stored thereon that are executable by the one or more processors to cause the media play back system to perform operations comprising: receiving, at the primary playback device, source audio data; obtaining n channels of satellite audio data from the source audio data to be played back via the satellite playback device; downmixing the n source channels of satellite audio data to m downmixed channels of audio satellite data according to a first downmixing scheme, wherein m<n, and wherein the first downmixing scheme is based at least in part on one or more first input parameters; and wirelessly transmitting the downmixed m channels of audio data to the satellite playback device for playback.

Example 2. The media playback system of any one of the Examples herein, wherein the operations further comprise: after wirelessly transmitting the downmixed m channels of audio data to the satellite playback device for playback, receiving, at the primary playback device, one or more second input parameters different from the one or more first input parameters; receiving, at the primary playback device, second source audio data; downmixing the n channels of satellite audio data to m channels of audio satellite data according to a second downmixing scheme different from the first, wherein the second downmixing scheme is based at least in part on one or more second input parameters; and wirelessly transmitting the downmixed m channels of audio data to the satellite playback device for playback.

Example 3. The media playback system of any one of the Examples herein, wherein the operations further comprise: after wirelessly transmitting the downmixed m channels of audio data to the satellite playback device for playback, receiving, at the primary playback device, second source audio data; determining that network conditions are sufficient to transmit n channels of satellite audio data of the second source audio data to the satellite playback device; and wirelessly transmitting the n channels of satellite audio data of the second source audio data to the satellite playback device.

Example 4. The media playback system of any one of the Examples herein, wherein the one or more input parameters comprise one or more of: an audio content parameter, a device location parameter, a listener location parameter, a playback responsibilities parameter, or an environmental acoustics parameter.

Example 5. The media playback system of any one of the Examples herein, wherein the operations further comprise: at the satellite playback device, upmixing the m channels of audio satellite data to generate n channels of audio satellite data; and playing back, via the satellite playback device, the upmixed n channels of audio data.

Example 6. The media playback system of any one of the Examples herein, wherein playing back the upmixed n channels of audio data comprises arraying the n channels to be output via a plurality of transducers of the satellite playback device such that each of the plurality of transducers outputs at least a portion of each of the n channels.

Example 7. The media playback system of any one of the Examples herein, further comprising playing back audio via the primary play back device in synchrony with playback of the upmixed n channels of audio data via the satellite playback device.

Example 8. The media playback system of any one of the Examples herein, wherein downmixing the n channels of satellite audio data to m channels of audio satellite data according to the first downmixing scheme comprises combining audio content from each of the n channels below a threshold frequency into a single one of the m downmixed channels.

Example 9. The media playback system of any one of the Examples herein, wherein downmixing the n channels of satellite audio data to m channels of audio satellite data according to the first downmixing scheme comprises (i) mapping a first channel of the n source channels to a first channel of the m downmixed channels (ii) mapping a first portion of a second channel of the n source channels to a first portion of a second channel of the m downmixed channels, and (iii) mapping a second portion of a third channel of the n source channels to a second portion of the second channel of the m downmixed channels.

Example 10. The media playback system of any one of the Examples herein, wherein downmixing the n channels of satellite audio data to m channels of audio satellite data according to the first downmixing scheme comprises mapping a second portion of the second channel of the n source channels to the second portion of the second channel of the m downmixed channels such that the second portion of the second channel of the m downmixed channels comprises a combination of (i) the second portion of the second channel of the n source channels and the second portion of the third channel of the n source channels.

Example 11. The media play back system of any one of the Examples herein, wherein the operations further comprise determining that wireless network conditions are insufficient to transmit the n source channels of satellite audio data to the satellite playback device.

Example 12. A method comprising: receiving, at a primary playback device, source audio data; obtaining n channels of satellite audio data from the source audio data to be played back via a satellite playback device; downmixing the n source channels of satellite audio data to m downmixed channels of audio satellite data according to a first downmixing scheme, wherein m<n, and wherein the first downmixing scheme is based at least in part on one or more first input parameters; and wirelessly transmitting the downmixed m channels of audio data to the satellite playback device for playback.

Example 13. The method of any one of the Examples herein, further comprising: after wirelessly transmitting the downmixed m channels of audio data to the satellite playback device for playback, receiving, at the primary playback device, one or more second input parameters different from the one or more first input parameters; receiving, at the primary playback device, second source audio data; downmixing the n channels of satellite audio data to m channels of audio satellite data according to a second downmixing scheme different from the first, wherein the second downmixing scheme is based at least in part on one or more second input parameters; and wirelessly transmitting the downmixed m channels of audio data to the satellite playback device for playback.

Example 14. The method of any one of the Examples herein, further comprising: after wirelessly transmitting the downmixed m channels of audio data to the satellite playback device for playback, receiving, at the primary play back device, second source audio data; determining that network conditions are sufficient to transmit n channels of satellite audio data of the second source audio data to the satellite playback device; and wirelessly transmitting the n channels of satellite audio data of the second source audio data to the satellite playback device.

Example 15. The method of any one of the Examples herein, wherein the one or more input parameters comprise one or more of: an audio content parameter, a device location parameter, a listener location parameter, a playback responsibilities parameter, or an environmental acoustics parameter.

Example 16. The method of any one of the Examples herein, further comprising: at the satellite playback device, upmixing the m channels of audio satellite data to generate n channels of audio satellite data; and playing back, via the satellite playback device, the upmixed n channels of audio data.

Example 17. The method of any one of the Examples herein, wherein playing back the upmixed n channels of audio data comprises arraying the n channels to be output via a plurality of transducers of the satellite playback device such that each of the plurality of transducers outputs at least a portion of each of the n channels.

Example 18. The method of any one of the Examples herein, further comprising playing back audio via the primary playback device in synchrony with playback of the upmixed n channels of audio data via the satellite playback device.

Example 19. The method of any one of the Examples herein, wherein downmixing the n channels of satellite audio data to m channels of audio satellite data according to the first downmixing scheme comprises combining audio content from each of the n channels below a threshold frequency into a single one of the m downmixed channels.

Example 20. The method of any one of the Examples herein, wherein downmixing the n channels of satellite audio data to m channels of audio satellite data according to the first downmixing scheme comprises (i) mapping a first channel of the n source channels to a first channel of the m downmixed channels (ii) mapping a first portion of a second channel of the n source channels to a first portion of a second channel of the m downmixed channels, and (iii) mapping a second portion of a third channel of the n source channels to a second portion of the second channel of the m downmixed channels.

Example 21. The method of any one of the Examples herein, wherein downmixing the n channels of satellite audio data to m channels of audio satellite data according to the first downmixing scheme comprises mapping a second portion of the second channel of the n source channels to the second portion of the second channel of the m downmixed channels such that the second portion of the second channel of the m downmixed channels comprises a combination of (i) the second portion of the second channel of the n source channels and the second portion of the third channel of the n source channels.

Example 22. The method of any one of the Examples herein, further comprising determining that wireless network conditions are insufficient to transmit the n source channels of satellite audio data to the satellite playback device.

Example 23. One or more tangible, non-transitory computer-readable media storing instructions that, when executed by one or more processors of a media playback system comprising a primary playback device and a satellite playback device, cause the media playback system to perform operations comprising: receiving, at a primary playback device, source audio data; obtaining n channels of satellite audio data from the source audio data to be played back via a satellite playback device; downmixing the n source channels of satellite audio data to m downmixed channels of audio satellite data according to a first downmixing scheme, wherein m<n, and wherein the first downmixing scheme is based at least in part on one or more first input parameters; and wirelessly transmitting the downmixed m channels of audio data to the satellite play back device for play back.

Example 24. The computer-readable media of any one of the Examples herein, wherein the operations further comprise: after wirelessly transmitting the downmixed m channels of audio data to the satellite playback device for playback, receiving, at the primary playback device, one or more second input parameters different from the one or more first input parameters; receiving, at the primary playback device, second source audio data; downmixing the n channels of satellite audio data to m channels of audio satellite data according to a second downmixing scheme different from the first, wherein the second downmixing scheme is based at least in part on one or more second input parameters; and wirelessly transmitting the downmixed m channels of audio data to the satellite play back device for playback.

Example 25. The computer-readable media of any one of the Examples herein, wherein the operations further comprise: after wirelessly transmitting the downmixed m channels of audio data to the satellite playback device for playback, receiving, at the primary play back device, second source audio data; determining that network conditions are sufficient to transmit n channels of satellite audio data of the second source audio data to the satellite play back device; and wirelessly transmitting the n channels of satellite audio data of the second source audio data to the satellite playback device.

Example 26. The computer-readable media of any one of the Examples herein, wherein the one or more input parameters comprise one or more of: an audio content parameter, a device location parameter, a listener location parameter, a playback responsibilities parameter, or an environmental acoustics parameter.

Example 27. The computer-readable media of any one of the Examples herein, wherein the operations further comprise: at the satellite playback device, upmixing the m channels of audio satellite data to generate n channels of audio satellite data; and playing back, via the satellite playback device, the upmixed n channels of audio data.

Example 28. The computer-readable media of any one of the Examples herein, wherein playing back the upmixed n channels of audio data comprises arraying the n channels to be output via a plurality of transducers of the satellite playback device such that each of the plurality of transducers outputs at least a portion of each of the n channels.

Example 29. The computer-readable media of any one of the Examples herein, further comprising playing back audio via the primary playback device in synchrony with playback of the upmixed n channels of audio data via the satellite playback device.

Example 30. The computer-readable media of any one of the Examples herein, wherein downmixing the n channels of satellite audio data to m channels of audio satellite data according to the first downmixing scheme comprises combining audio content from each of the n channels below a threshold frequency into a single one of the m downmixed channels.

Example 31. The computer-readable media of any one of the Examples herein, wherein downmixing the n channels of satellite audio data to m channels of audio satellite data according to the first downmixing scheme comprises (i) mapping a first channel of the n source channels to a first channel of the m downmixed channels (ii) mapping a first portion of a second channel of the n source channels to a first portion of a second channel of the m downmixed channels, and (iii) mapping a second portion of a third channel of the n source channels to a second portion of the second channel of the m downmixed channels.

Example 32. The computer-readable media of any one of the Examples herein, wherein downmixing the n channels of satellite audio data to m channels of audio satellite data according to the first downmixing scheme comprises mapping a second portion of the second channel of the n source channels to the second portion of the second channel of the m downmixed channels such that the second portion of the second channel of the m downmixed channels comprises a combination of (i) the second portion of the second channel of the n source channels and the second portion of the third channel of the n source channels.

Example 33. The computer-readable media of any one of the Examples herein, wherein the operations further comprise determining that wireless network conditions are insufficient to transmit the n source channels of satellite audio data to the satellite playback device.

Example 34. A media playback system comprising: a plurality of playback devices including at least a first playback device and a second playback device one or more processors; and data storage having instructions stored thereon that are executable by the one or more processors to cause the media playback system to perform operations comprising: receiving a request to form a bonded zone including the plurality of playback devices configured to synchronously play back audio content; determining, for a first playback parameter, a first value for each of the plurality of playback devices; determining, for a second playback parameter, a second value for each of the plurality of playback devices; based on the first play back parameter value for the first playback device, adjusting the first playback parameter value for the second playback device; based on the second playback parameter value for the second playback device, adjusting the second playback parameter value for the first playback device; and synchronously playing back audio content via the plurality of playback devices in the bonded zone.

Example 35. The media play back system of any one of the Examples herein, wherein the first playback parameter comprises a characteristic playback magnitude, and wherein the second playback parameter comprises a characteristic playback phase.

Example 36. The media play back system of any one of the Examples herein, wherein adjusting the first playback parameter value for the second playback device comprises adjusting the first playback parameter value for the second playback device to be closer to the first play back parameter value for the first playback device, and wherein adjusting the second playback parameter for the first playback device comprises adjusting the second playback parameter value for the second playback device to be closer to the second play back parameter value for the second playback device.

Example 37. The media playback system of any one of the Examples herein, wherein the operations further comprise: receiving a request to add a third playback device to the bonded zone; determining, for the first play back parameter, a first value for the third playback device; and based on the first playback parameter value for the third playback device, adjusting the first playback parameter value for each of the first playback device and the second play back device.

Example 38. The media playback system of any one of the Examples herein, wherein the operations further comprise: receiving a request to assign different playback responsibilities within the bonded zone to the first playback device; and based on the different playback responsibilities, adjusting the second play back parameter value for the first playback device.

Example 39. The media play back system of any one of the Examples herein, wherein the operations further comprise: after determining the first play back parameter values, selecting the first playback device as a first reference device for the first playback parameter; and after determining the second playback parameter values, selecting the second playback device as a second reference device for the second playback parameter.

Example 40. The media play back system of any one of the Examples herein, wherein the operations further comprise: determining that the first playback device has moved its location; based on determining that the first playback device has moved, selecting a different play back device as the first reference device for the first playback parameter; and based on the first playback parameter value for the first reference device, adjusting the first playback parameter value for at least the first playback device.

Example 41. The media play back system of any one of the Examples herein, wherein determining, for the first play back parameter, a first value for each of the plurality of play back devices comprises capturing audio output via each of the plurality of playback devices via one or more microphones, and analyzing the captured audio output to determine the first play back parameter values.

Example 42. A method comprising: receiving a request to form a bonded zone including a plurality of playback devices configured to synchronously play back audio content, the plurality of playback devices including at least a first playback device and a second playback device; determining, for a first playback parameter, a first value for each of the plurality of playback devices; determining, for a second playback parameter, a second value for each of the plurality of play back devices; based on the first playback parameter value for the first playback device, adjusting the first playback parameter value for the second play back device; based on the second playback parameter value for the second playback device, adjusting the second playback parameter value for the first play back device; and synchronously playing back audio content via the plurality of playback devices in the bonded zone.

Example 43. The method of any one of the Examples herein, wherein the first playback parameter comprises a characteristic playback magnitude, and wherein the second play back parameter comprises a characteristic play back phase.

Example 44. The method of any one of the Examples herein, wherein adjusting the first playback parameter value for the second playback device comprises adjusting the first playback parameter value for the second playback device to be closer to the first playback parameter value for the first playback device, and wherein adjusting the second playback parameter for the first playback device comprises adjusting the second playback parameter value for the second playback device to be closer to the second playback parameter value for the second playback device.

Example 45. The method of any one of the Examples herein, further comprising: receiving a request to add a third playback device to the bonded zone; determining, for the first playback parameter, a first value for the third play back device; and based on the first playback parameter value for the third playback device, adjusting the first playback parameter value for each of the first playback device and the second playback device.

Example 46. The method of any one of the Examples herein, further comprising: receiving a request to assign different playback responsibilities within the bonded zone to the first playback device; and based on the different playback responsibilities, adjusting the second play back parameter value for the first playback device.

Example 47. The method of any one of the Examples herein, further comprising: after determining the first playback parameter values, selecting the first playback device as a first reference device for the first playback parameter; and after determining the second play back parameter values, selecting the second playback device as a second reference device for the second playback parameter.

Example 48. The method of any one of the Examples herein, further comprising: determining that the first playback device has moved its location; based on determining that the first play back device has moved, selecting a different playback device as the first reference device for the first playback parameter; and based on the first playback parameter value for the first reference device, adjusting the first playback parameter value for at least the first playback device.

Example 49. The method of any one of the Examples herein, wherein determining, for the first playback parameter, a first value for each of the plurality of playback devices comprises capturing audio output via each of the plurality of play back devices via one or more microphones, and analyzing the captured audio output to determine the first playback parameter values.

Example 50. One or more tangible, non-transitory computer-readable media storing instructions that, when executed by one or more processors of a media playback system, cause the media playback system to perform operations comprising: receiving a request to form a bonded zone including a plurality of playback devices configured to synchronously play back audio content, the plurality of playback devices comprising at least a first playback device and a second playback device; determining, for a first playback parameter, a first value for each of the plurality of play back devices; determining, for a second playback parameter, a second value for each of the plurality of playback devices; based on the first playback parameter value for the first playback device, adjusting the first play back parameter value for the second playback device; based on the second playback parameter value for the second playback device, adjusting the second playback parameter value for the first playback device; and synchronously playing back audio content via the plurality of playback devices in the bonded zone.

Example 51. The computer-readable media of any one of the Examples herein, wherein the first playback parameter comprises a characteristic playback magnitude, and wherein the second playback parameter comprises a characteristic playback phase.

Example 52. The computer-readable media of any one of the Examples herein, wherein adjusting the first playback parameter value for the second playback device comprises adjusting the first playback parameter value for the second playback device to be closer to the first playback parameter value for the first playback device, and wherein adjusting the second playback parameter for the first playback device comprises adjusting the second playback parameter value for the second playback device to be closer to the second playback parameter value for the second playback device.

Example 53. The computer-readable media of any one of the Examples herein, wherein the operations further comprise: receiving a request to add a third playback device to the bonded zone; determining, for the first playback parameter, a first value for the third playback device; and based on the first playback parameter value for the third playback device, adjusting the first play back parameter value for each of the first playback device and the second playback device.

Example 54. The computer-readable media of any one of the Examples herein, wherein the operations further comprise: receiving a request to assign different playback responsibilities within the bonded zone to the first playback device; and based on the different playback responsibilities, adjusting the second playback parameter value for the first playback device.

Example 55. The computer-readable media of any one of the Examples herein, wherein the operations further comprise: after determining the first playback parameter values, selecting the first playback device as a first reference device for the first playback parameter; and after determining the second playback parameter values, selecting the second playback device as a second reference device for the second playback parameter.

Example 56. The computer-readable media of any one of the Examples herein, wherein the operations further comprise: determining that the first play back device has moved its location; based on determining that the first playback device has moved, selecting a different play back device as the first reference device for the first playback parameter; and based on the first playback parameter value for the first reference device, adjusting the first playback parameter value for at least the first playback device.

Example 57. The computer-readable media of any one of the Examples herein, wherein determining, for the first playback parameter, a first value for each of the plurality of play back devices comprises capturing audio output via each of the plurality of play back devices via one or more microphones, and analyzing the captured audio output to determine the first play back parameter values.

Example 58. A media playback system comprising: a plurality of playback devices including a rear satellite playback device; one or more processors; and data storage having instructions stored thereon that, when executed by the one or more processors, cause the media playback system to perform operations comprising: receiving, at the media play back, multi-channel audio content comprising a side surround channel and a rear surround channel; playing back, via the rear satellite playback device, the side surround channel at a first magnitude; playing back, via the rear satellite playback device, the rear surround channel at a second magnitude; receiving a trigger indication; based on the trigger indication: playing back, via the rear satellite playback device, the side surround channel at a third magnitude lower than the first magnitude; and playing back, via the rear satellite playback device, the rear surround channel at a fourth magnitude greater than the second magnitude.

Example 59. The media play back system of any one of the Examples herein, wherein the trigger indication comprises a user input (e.g., user input via a controller device, voice input, etc.).

Example 60. The media play back system of any one of the Examples herein, wherein the trigger indication comprises detection of an environmental acoustics parameter (e.g., calibration, object detection in environment), a device position parameter, or a listener location parameter.

Example 61. The media play back system of any one of the Examples herein, wherein the rear satellite playback device comprises a plurality of audio transducers.

Example 62. The media playback system of any one of the Examples herein, wherein the relative playback magnitudes of the side surround channel and the rear surround channel determines a perceived width of the audio playback.

Example 63. The media play back system of any one of the Examples herein, wherein the operations further comprise: receiving a second trigger indication; and based on the trigger indication: playing back, via the rear satellite playback device, the side surround channel at a fifth magnitude lower than the third magnitude; and playing back, via the rear satellite play back device, the rear surround channel at a sixth magnitude greater than the fourth magnitude.

Example 64. The media play back system of any one of the Examples herein, wherein the side surround channel is a right side surround channel, the rear surround channel is a right rear surround channel, and the rear satellite playback device is a rear right satellite playback device, the media playback system further comprising a left rear satellite playback device, wherein the operations further comprise: while playing back, via the rear right satellite playback device, the right side surround channel at the first magnitude, playing back, via the left rear satellite playback device, a left side surround channel at the first magnitude; while playing back, via the rear right satellite playback device, the rear right surround channel at the second magnitude, playing back, via the left rear satellite playback device, a left rear surround channel at the second magnitude; based on the trigger indication: playing back, via the left rear satellite playback device, the left side surround channel at the third magnitude lower than the first magnitude; and playing back, via the left rear satellite playback device, the left rear surround channel at the fourth magnitude greater than the second magnitude.

Example 65. A method comprising: receiving, at a media play back system comprising a plurality of playback devices including a rear satellite playback device, multi-channel audio content comprising a side surround channel and a rear surround channel; playing back, via the rear satellite playback device, the side surround channel at a first magnitude; playing back, via the rear satellite playback device, the rear surround channel at a second magnitude; receiving a trigger indication; based on the trigger indication: playing back, via the rear satellite playback device, the side surround channel at a third magnitude lower than the first magnitude; and playing back, via the rear satellite playback device, the rear surround channel at a fourth magnitude greater than the second magnitude.

Example 66. The method of any one of the Examples herein, wherein the trigger indication comprises a user input (e.g., user input via a controller device, voice input, etc.) Example 67. The method of any one of the Examples herein, wherein the trigger indication comprises detection of an environmental acoustics parameter (e.g., calibration, object detection in environment), a device position parameter, or a listener location parameter.

Example 68. The method of any one of the Examples herein, wherein the rear satellite playback device comprises a plurality of audio transducers.

Example 69. The method of any one of the Examples herein, wherein the relative playback magnitudes of the side surround channel and the rear surround channel determines a perceived width of the audio playback.

Example 70. The method of any one of the Examples herein, further comprising: receiving a second trigger indication; and based on the second trigger indication: playing back, via the rear satellite playback device, the side surround channel at a fifth magnitude lower than the third magnitude; and playing back, via the rear satellite playback device, the rear surround channel at a sixth magnitude greater than the fourth magnitude.

Example 71. The method of any one of the Examples herein, wherein the side surround channel is a right side surround channel, the rear surround channel is a right rear surround channel, and the rear satellite play back device is a rear right satellite playback device, the method further comprising: while playing back, via the rear right satellite play back device, the right side surround channel at the first magnitude, playing back, via a left rear satellite playback device, a left side surround channel at the first magnitude; while playing back, via the rear right satellite playback device, the rear right surround channel at the second magnitude, playing back, via the left rear satellite playback device, a left rear surround channel at the second magnitude; based on the trigger indication: playing back, via the left rear satellite playback device, the left side surround channel at the third magnitude lower than the first magnitude; and playing back, via the left rear satellite playback device, the left rear surround channel at the fourth magnitude greater than the second magnitude.

Example 72. One or more tangible, non-transitory computer-readable media storing instructions thereon that, when executed by one or more processors of a media play back system, cause the media playback system to perform operations comprising: receiving, at the media playback, multi-channel audio content comprising a side surround channel and a rear surround channel; playing back, via a rear satellite playback device of the media playback system, the side surround channel at a first magnitude; playing back, via the rear satellite playback device, the rear surround channel at a second magnitude; receiving a trigger indication; based on the trigger indication: playing back, via the rear satellite playback device, the side surround channel at a third magnitude lower than the first magnitude; and playing back, via the rear satellite playback device, the rear surround channel at a fourth magnitude greater than the second magnitude.

Example 73. The computer-readable media of any one of the Examples herein, wherein the trigger indication comprises a user input (e.g., user input via a controller device, voice input, etc.).

Example 74. The computer-readable media of any one of the Examples herein, wherein the trigger indication comprises detection of an environmental acoustics parameter (e.g., calibration, object detection in environment), a device position parameter, or a listener location parameter.

Example 75. The computer-readable media of any one of the Examples herein, wherein the rear satellite play back device comprises a plurality of audio transducers.

Example 76. The computer-readable media of any one of the Examples herein, wherein the relative playback magnitudes of the side surround channel and the rear surround channel determines a perceived width of the audio playback.

Example 77. The computer-readable media of any one of the Examples herein, wherein the operations further comprise: receiving a second trigger indication; and based on the second trigger indication: playing back, via the rear satellite playback device, the side surround channel at a fifth magnitude lower than the third magnitude; and playing back, via the rear satellite playback device, the rear surround channel at a sixth magnitude greater than the fourth magnitude.

Example 78. The computer-readable media of any one of the Examples herein, wherein the side surround channel is a right side surround channel, the rear surround channel is a right rear surround channel, and the rear satellite playback device is a rear right satellite playback device, the media playback system further comprising a left rear satellite playback device, wherein the operations further comprise: while playing back, via the rear right satellite playback device, the right side surround channel at the first magnitude, playing back, via the left rear satellite playback device, a left side surround channel at the first magnitude; while playing back, via the rear right satellite playback device, the rear right surround channel at the second magnitude, playing back, via the left rear satellite playback device, a left rear surround channel at the second magnitude; based on the trigger indication: playing back, via the left rear satellite playback device, the left side surround channel at the third magnitude lower than the first magnitude; and playing back, via the left rear satellite playback device, the left rear surround channel at the fourth magnitude greater than the second magnitude.

Example 79. A media playback system comprising: a plurality of playback devices including a front center playback device and a front satellite playback device; one or more processors; and data storage having instructions stored thereon that, when executed by the one or more processors, cause the media playback system to perform operations comprising: receiving, at the media playback system, multi-channel audio content comprising a front surround channel; playing back the front surround channel via only the front satellite playback device; receiving a trigger indication; and based on the trigger indication, playing back the front surround channel via both the front satellite playback device and the center front play back device in synchrony.

Example 80. The media play back system of any one of the Examples herein, wherein the trigger indication comprises a user input (e.g., user input via a controller device, voice input, etc.).

Example 81. The media playback system of any one of the Examples herein, wherein the trigger indication comprises detection of an environmental acoustics parameter (e.g., calibration, object detection in environment), a device position parameter, or a listener location parameter.

Example 82. The media playback system of any one of the Examples herein, wherein the operations further comprise: receiving a second trigger indication; and based on the second trigger indication, decreasing a playback magnitude of the front surround channel via the front satellite playback device and increasing a playback magnitude of the front surround channel via the center front playback device.

Example 83. The media play back system of any one of the Examples herein, wherein the relative playback magnitudes of the front surround channel via the front satellite play back device and via the center front playback device determines a perceived width of the audio play back.

Example 84. The media playback system of any one of the Examples herein, wherein the front surround channel is a front right surround channel, and the front satellite playback device is a front right satellite playback device, the operations further comprising: while playing back the front right surround channel via only the front right satellite playback device, synchronously playing back a front left surround channel via only a front left satellite play back device; and while playing back the front right surround channel via both the front right satellite playback device and the center front playback device in synchrony, synchronously playing back the front left surround channel via both the front left satellite playback device and the center front playback device.

Example 85. The media playback system of any one of the Examples herein, wherein the center front playback device comprises a soundbar having a plurality of transducers.

Example 86. A method comprising: receiving, at a media play back system comprising a plurality of playback devices including a front satellite play back device, multi-channel audio content comprising a front surround channel; playing back the front surround channel via only the front satellite playback device; receiving a trigger indication; and based on the trigger indication, playing back the front surround channel via both the front satellite playback device and a center front playback device in synchrony.

Example 87. The method of any one of the Examples herein, wherein the trigger indication comprises a user input (e.g., user input via a controller device, voice input, etc.).

Example 88. The method of any one of the Examples herein, wherein the trigger indication comprises detection of an environmental acoustics parameter (e.g., calibration, object detection in environment), a device position parameter, or a listener location parameter.

Example 89. The method of any one of the Examples herein, further comprising: receiving a second trigger indication; and based on the second trigger indication, decreasing a playback magnitude of the front surround channel via the front satellite playback device and increasing a playback magnitude of the front surround channel via the center front playback device.

Example 90. The method of any one of the Examples herein, wherein the relative playback magnitudes of the front surround channel via the front satellite playback device and via the center front playback device determines a perceived width of the audio playback.

Example 91. The method of any one of the Examples herein, wherein the front surround channel is a front right surround channel, and the front satellite playback device is a front right satellite playback device, the method further comprising: while playing back the front right surround channel via only the front right satellite playback device, synchronously playing back a front left surround channel via only a front left satellite playback device; and while playing back the front right surround channel via both the front right satellite play back device and the center front playback device in synchrony, synchronously playing back the front left surround channel via both the front left satellite playback device and the center front playback device.

Example 92. The method of any one of the Examples herein, wherein the center front play back device comprises a soundbar having a plurality of transducers.

Example 93. One or more tangible, non-transitory computer-readable media storing instructions that when executed by one or more processors of a media playback system, cause the media play back system to perform operations comprising: receiving, at the media play back system, multi-channel audio content comprising a front surround channel; playing back the front surround channel via only a front satellite play back device of the media play back system; receiving a trigger indication; and based on the trigger indication, playing back the front surround channel via both the front satellite playback device and a center front playback device of the media playback system in synchrony.

Example 94. The computer-readable media of any one of the Examples herein, wherein the trigger indication comprises a user input (e.g., user input via a controller device, voice input, etc.).

Example 95. The computer-readable media of any one of the Examples herein, wherein the trigger indication comprises detection of an environmental acoustics parameter (e.g., calibration, object detection in environment), a device position parameter, or a listener location parameter.

Example 96. The computer-readable media of any one of the Examples herein, wherein the operations further comprise: receiving a second trigger indication; and based on the second trigger indication, decreasing a playback magnitude of the front surround channel via the front satellite playback device and increasing a playback magnitude of the front surround channel via the center front playback device.

Example 97. The computer-readable media of any one of the Examples herein, wherein the relative playback magnitudes of the front surround channel via the front satellite play back device and via the center front playback device determines a perceived width of the audio playback.

Example 98. The computer-readable media of any one of the Examples herein, wherein the front surround channel is a front right surround channel, and the front satellite playback device is a front right satellite playback device, the operations further comprising: while playing back the front right surround channel via only the front right satellite playback device, synchronously playing back a front left surround channel via only a front left satellite playback device; and while playing back the front right surround channel via both the front right satellite playback device and the center front playback device in synchrony, synchronously playing back the front left surround channel via both the front left satellite playback device and the center front play back device.

Example 99. The computer-readable media of any one of the Examples herein, wherein the center front playback device comprises a soundbar having a plurality of transducers.

Example 100. A playback device comprising: a plurality of audio transducers configured to output audio along a plurality of sound axes including at least a forward-firing axis and a side-firing axis; one or more processors; and data storage having instructions thereon that, when executed by the one or more processors, cause the playback device to perform operations comprising: receiving multichannel audio content including a first audio channel; playing back at least a first proportion of the first audio channel via the forward-firing axis; obtaining an indication of orientation of the playback device relative to the environment; and based at least in part on the orientation indication, modifying audio playback such that at least a second proportion of the first channel is played back via the side-firing axis rather than via the forward-firing axis.

Example 101. The playback device of any one of the Examples herein, wherein the operations further comprise: while playing back at least the first proportion of the first audio channel via the forward-firing axis, playing back none of the first audio channel via the side-firing axis; and while playing back at least the second proportion of the first audio channel via the side-firing axis, playing back none of the first audio channel via the forward-firing axis.

Example 102. The playback device of any one of the Examples herein, wherein the operations further comprise: while playing back at least the first proportion of the first audio channel via the forward-firing axis, playing back a third proportion of the first audio channel via the side-firing axis; and while playing back at least the second portion of the first audio channel via the side-firing axis, playing back a fourth proportion of the first audio channel via the forward-firing axis, wherein the first proportion is greater than the fourth proportion, and the second proportion is greater than the third proportion.

Example 103. The playback device of any one of the Examples herein, wherein the operations further comprise modifying audio playback based at least in part on the orientation indication such that a third proportion of the first channel is output via the forward-firing axis, the third proportion being less than the first proportion.

Example 104. The playback device of any one of the Examples herein, wherein the operations further comprise modifying audio playback based at least in part on the orientation indication such that none of the first audio channel is output via the forward-firing axis.

Example 105. The playback device of any one of the Examples herein, wherein the playback device is a front left satellite playback device, the first channel is a front left channel, and the side-firing axis is a right side-firing axis, and wherein the indication of orientation reflects that the forward-firing axis is oriented forward of an intended listening location within the environment.

Example 106. The playback device of any one of the Examples herein, wherein the right side-firing axis is oriented nearer to the intended listening location than the forward-firing axis.

Example 107. The playback device of any one of the Examples herein, wherein the playback device is a front left satellite playback device, the first channel is a front left channel, and the side-firing axis is a left side-firing axis, and wherein the indication of orientation reflects that the forward-firing axis is oriented rearward of an intended listening location within the environment.

Example 108. The playback device of any one of the Examples herein, wherein the left side-firing axis is oriented nearer to the intended listening location than the forward-firing axis.

Example 109. The playback device of any one of the Examples herein, wherein obtaining an indication of orientation comprises determining an angular orientation of the playback device.

Example 110. The playback device of any one of the Examples herein, wherein obtaining an indication of orientation comprises receiving, via the network interface, an angular orientation of the play back device.

Example 111. A method comprising: a plurality of audio transducers configured to output audio along a plurality of sound axes including at least a forward-firing axis and a side-firing axis; receiving, at a playback device, multichannel audio content including a first audio channel, the playback device comprising a plurality of audio transducers configured to output audio along a plurality of sound axes including at least a forward-firing axis and a side-firing axis, playing back at least a first proportion of the first audio channel via the forward-firing axis; obtaining an indication of orientation of the playback device relative to the environment; and based at least in part on the orientation indication, modifying audio playback such that at least a second proportion of the first channel is played back via the side-firing axis rather than via the forward-firing axis.

Example 112. The method of any one of the Examples herein, further comprising: while playing back at least the first proportion of the first audio channel via the forward-firing axis, playing back none of the first audio channel via the side-firing axis; and while playing back at least the second proportion of the first audio channel via the side-firing axis, playing back none of the first audio channel via the forward-firing axis.

Example 113. The method of any one of the Examples herein, further comprising: while playing back at least the first proportion of the first audio channel via the forward-firing axis, playing back a third proportion of the first audio channel via the side-firing axis; and while playing back at least the second portion of the first audio channel via the side-firing axis, playing back a fourth proportion of the first audio channel via the forward-firing axis, wherein the first proportion is greater than the fourth proportion, and the second proportion is greater than the third proportion.

Example 114. The method of any one of the Examples herein, further comprising comprise modifying audio playback based at least in part on the orientation indication such that a third proportion of the first channel is output via the forward-firing axis, the third proportion being less than the first proportion.

Example 115. The method of any one of the Examples herein, further comprising modifying audio playback based at least in part on the orientation indication such that none of the first audio channel is output via the forward-firing axis.

Example 116. The method of any one of the Examples herein, wherein the play back device is a front left satellite playback device, the first channel is a front left channel, and the side-firing axis is a right side-firing axis, and wherein the indication of orientation reflects that the forward-firing axis is oriented forward of an intended listening location within the environment.

Example 117. The method of any one of the Examples herein, wherein the right side-firing axis is oriented nearer to the intended listening location than the forward-firing axis.

Example 118. The method of any one of the Examples herein, wherein the playback device is a front left satellite playback device, the first channel is a front left channel, and the side-firing axis is a left side-firing axis, and wherein the indication of orientation reflects that the forward-firing axis is oriented rearward of an intended listening location within the environment.

Example 119. The method of any one of the Examples herein, wherein the left side-firing axis is oriented nearer to the intended listening location than the forward-firing axis.

Example 120. The method of any one of the Examples herein, wherein obtaining an indication of orientation comprises determining an angular orientation of the playback device.

Example 121. The method of any one of the Examples herein, wherein obtaining an indication of orientation comprises receiving, via the network interface, an angular orientation of the play back device.

Example 122. One or more tangible, non-transitory computer-readable media storing instructions thereon that, when executed by one or more processors of a playback device configured to output audio along a plurality of sound axes including at least a forward-firing axis and a side-firing axis, cause the playback device to perform operations comprising: receiving multichannel audio content including a first audio channel; playing back at least a first proportion of the first audio channel via the forward-firing axis; obtaining an indication of orientation of the playback device relative to the environment; and based at least in part on the orientation indication, modifying audio playback such that at least a second proportion of the first channel is played back via the side-firing axis rather than via the forward-firing axis.

Example 123. The computer-readable media of any one of the Examples herein, wherein the operations further comprise: while playing back at least the first proportion of the first audio channel via the forward-firing axis, playing back none of the first audio channel via the side-firing axis; and while playing back at least the second proportion of the first audio channel via the side-firing axis, playing back none of the first audio channel via the forward-firing axis.

Example 124. The computer-readable media of any one of the Examples herein, wherein the operations further comprise: while playing back at least the first proportion of the first audio channel via the forward-firing axis, playing back a third proportion of the first audio channel via the side-firing axis; and while playing back at least the second portion of the first audio channel via the side-firing axis, playing back a fourth proportion of the first audio channel via the forward-firing axis, wherein the first proportion is greater than the fourth proportion, and the second proportion is greater than the third proportion.

Example 125. The computer-readable media of any one of the Examples herein, wherein the operations further comprise modifying audio playback based at least in part on the orientation indication such that a third proportion of the first channel is output via the forward-firing axis, the third proportion being less than the first proportion.

Example 126. The computer-readable media of any one of the Examples herein, wherein the operations further comprise modifying audio playback based at least in part on the orientation indication such that none of the first audio channel is output via the forward-firing axis.

Example 127. The computer-readable media of any one of the Examples herein, wherein the playback device is a front left satellite playback device, the first channel is a front left channel, and the side-firing axis is a right side-firing axis, and wherein the indication of orientation reflects that the forward-firing axis is oriented forward of an intended listening location within the environment.

Example 128. The computer-readable media of any one of the Examples herein, wherein the right side-firing axis is oriented nearer to the intended listening location than the forward-firing axis.

Example 129. The computer-readable media of any one of the Examples herein, wherein the playback device is a front left satellite playback device, the first channel is a front left channel, and the side-firing axis is a left side-firing axis, and wherein the indication of orientation reflects that the forward-firing axis is oriented rearward of an intended listening location within the environment.

Example 130. The computer-readable media of any one of the Examples herein, wherein the left side-firing axis is oriented nearer to the intended listening location than the forward-firing axis.

Example 131. The computer-readable media of any one of the Examples herein, wherein obtaining an indication of orientation comprises determining an angular orientation of the playback device.

Example 132. The computer-readable media of any one of the Examples herein, wherein obtaining an indication of orientation comprises receiving, via the network interface, an angular orientation of the playback device.

Example 133. A playback device comprising: a forward-firing transducer configured to direct sound along a first sound axis; an up-firing transducer configured to direct sound along a second sound axis that is vertically angled with respect to the first sound axis; a side-firing transducer or array configured to direct sound along a third axis that is horizontally angled with respect to the first sound axis; one or more processors; and data storage having instructions stored thereon that, when executed by the one or more processors, cause the playback device to perform operations comprising: receiving, at the playback device, audio input including a vertical content signal; playing back audio based on the vertical content signal via at least the up-firing transducer and the side-firing transducer or array; and playing back a null signal via the forward-firing transducer, wherein the null signal cancels out a portion of the played back vertical content signal along the first sound axis.

Example 134. The playback device of any one of the Examples herein, wherein the playback device is configured to perform the operations while in a first standalone playback mode, and wherein the playback device is further configured to perform second operations while in a second playback mode in which the playback device is bonded with a second playback device for synchronous playback, the second operations comprising: playing back the vertical content signal via at least the up-firing transducer; and playing back the null signal via at least the side-firing transducer or array, wherein the null signal cancels out the portion of the vertical content signal along the first sound axis.

Example 135. The playback device of any one of the Examples herein wherein playing back the vertical content signal via at least the up-firing transducer comprises playing back audio based on the vertical content via the up-firing transducer and the forward-firing transducer.

Example 136. The playback device of any one of the Examples herein, wherein the null signal is restricted to a frequency band that includes 1 kHz, the frequency band having a bandwidth that is less than about 5.0 kHz, 4.5 kHz, 4.0 kHz, 3.5 kHz, 3.0 kHz, 2.5 kHz, 2.0 kHz, 1.5 kHz, 1.0 kHz, or 0.5 kHz.

Example 137. The playback device of any one of the Examples herein, wherein the null signal is restricted to a frequency band that includes 1 kHz, the frequency band having a bandwidth that is greater than about 5.0 kHz, 4.5 kHz, 4.0 kHz, 3.5 kHz, 3.0 kHz, 2.5 kHz, 2.0 kHz, 1.5 kHz, 1.0 kHz, or 0.5 kHz.

Example 138. The playback device of any one of the Examples herein, wherein the null signal is restricted to a frequency band that excludes frequencies below a lower threshold frequency, and wherein the lower threshold frequency is greater than about 200 Hz, 300 Hz, 400 Hz, 500 Hz, 600 Hz, 700 Hz, 800 Hz, 900 Hz, or 1 kHz.

Example 139. The playback device of any one of the Examples herein, wherein the null signal is restricted to a frequency band that excludes frequencies above an upper threshold frequency, and wherein the upper threshold frequency less than about 1.0 kHz, 1.5 kHz, 2.0 kHz, 2.5 kHz, 3.0 kHz, 3.5 kHz, or 4.0 kHz.

Example 140. The playback device of any one of the Examples herein, wherein the null signal comprises the vertical content signal being phase-shifted such that the null signal destructively interferes with the portion of the audio played back based on the vertical content signal along the first sound axis.

Example 141. The playback device of any one of the Examples herein, wherein playing back the null signal via the forward-firing transducer is delayed with respect to playing back audio based on the vertical content signal via at least the up-firing transducer and the side-firing transducer or array.

Example 142. A method of playing back audio content comprising: receiving, at a playback device, audio input including a vertical content signal, wherein the audio playback device comprises a forward-firing transducer configured to direct sound along a first sound axis, an up-firing transducer configured to direct sound along a second sound axis that is vertically angled with respect to the first sound axis, and a side-firing transducer or array configured to direct sound along a third axis that is horizontally angled with respect to the first sound axis; playing back audio based on the vertical content signal via at least the up-firing transducer and the side-firing transducer or array; and playing back a null signal via the forward-firing transducer, wherein the null signal cancels out a portion of the audio played back based on the vertical content signal along the first sound axis.

Example 143. The method of any one of the Examples herein, wherein the preceding operations are performed while the play back device is in a first standalone playback mode, the method further comprising transitioning to a second playback mode in which the play back device is bonded with a second playback device for synchronous playback, and while in the second mode: playing back audio based on the vertical content signal via at least the up-firing transducer; and playing back the null signal via at least the side-firing transducer or array, wherein the null signal cancels out the portion of the vertical content signal along the first sound axis.

Example 144. The method of any one of the Examples herein, wherein playing back audio based on the vertical content signal via at least the up-firing transducer comprises playing back audio based on the vertical content signal via the up-firing transducer and the forward-firing transducer.

Example 145. The method of any one of the Examples herein, wherein the null signal is restricted to a frequency band that includes 1 kHz, the frequency band having a bandwidth that is less than about 5.0 kHz, 4.5 kHz, 4.0 kHz, 3.5 kHz, 3.0 kHz, 2.5 kHz, 2.0 kHz, 1.5 kHz, 1.0 kHz, or 0.5 kHz.

Example 146. The method of any one of the Examples herein, wherein the null signal is restricted to a frequency band that includes 1 kHz, the frequency band having a bandwidth that is greater than about 5.0 kHz, 4.5 kHz, 4.0 kHz, 3.5 kHz, 3.0 kHz, 2.5 kHz, 2.0 kHz, 1.5 kHz, 1.0 kHz, or 0.5 kHz.

Example 147. The method of any one of the Examples herein, wherein the null signal is restricted to a frequency band that excludes frequencies below a lower threshold frequency, and wherein the lower threshold frequency is greater than about 200 Hz, 300 Hz, 400 Hz, 500 Hz, 600 Hz, 700 Hz, 800 Hz, 900 Hz, or 1 kHz.

Example 148. The method of any one of the Examples herein, wherein the null signal is restricted to a frequency band that excludes frequencies above an upper threshold frequency, and wherein the upper threshold frequency less than about 1.0 kHz, 1.5 kHz, 2.0 kHz, 2.5 kHz, 3.0 kHz, 3.5 kHz, or 4.0 kHz.

Example 149. The method of any one of the Examples herein, wherein the null signal comprises the vertical content signal being phase-shifted such that the null signal destructively interferes with the portion of the audio played back based on the vertical content signal along the first sound axis.

Example 150. The method of any one of the Examples herein, wherein playing back the null signal via the forward-firing transducer is delayed with respect to playing back audio based on the vertical content signal via at least the up-firing transducer and the side-firing transducer or array.

Example 151. One or more tangible, non-transitory computer-readable media storing instructions that, when executed by one or more processors of a playback device, cause the playback device to perform operations comprising: a forward-firing transducer configured to direct sound along a first sound axis; an up-firing transducer configured to direct sound along a second sound axis that is vertically angled with respect to the first sound axis; a side-firing transducer or array configured to direct sound along a third axis that is horizontally angled with respect to the first sound axis; receiving, at the play back device, audio input including a vertical content signal; playing back audio based on the vertical content signal via at least an up-firing transducer and a side-firing transducer or array of the playback device; and playing back a null signal via a forward-firing transducer of the playback device, the forward-firing transducer being configured to direct sound along a first sound axis, wherein the null signal cancels out a portion of the audio played back based on the vertical content signal along the first sound axis.

Example 152. The computer-readable media of any one of the Examples herein, wherein the playback device is configured to perform the operations while in a first standalone playback mode, and wherein the playback device is further configured to perform second operations while in a second playback mode in which the playback device is bonded with a second playback device for synchronous playback, the second operations comprising: playing back audio based on the vertical content signal via at least the up-firing transducer; and playing back the null signal via at least the side-firing transducer or array, wherein the null signal cancels out the portion of the vertical content signal along the first sound axis.

Example 153. The computer-readable media of any one of the Examples herein, wherein playing back audio based on the vertical content signal via at least the up-firing transducer comprises playing back audio based on the vertical content signal via the up-firing transducer and the forward-firing transducer.

Example 154. The computer-readable media of any one of the Examples herein, wherein the null signal is restricted to a frequency band that includes 1 kHz, the frequency band having a bandwidth that is less than about 5.0 kHz, 4.5 kHz, 4.0 kHz, 3.5 kHz, 3.0 kHz, 2.5 kHz, 2.0 kHz, 1.5 kHz, 1.0 kHz, or 0.5 kHz.

Example 155. The computer-readable media of any one of the Examples herein, wherein the null signal is restricted to a frequency band that includes 1 kHz, the frequency band having a bandwidth that is greater than about 5.0 kHz, 4.5 kHz, 4.0 kHz, 3.5 kHz, 3.0 kHz, 2.5 kHz, 2.0 kHz, 1.5 kHz, 1.0 kHz, or 0.5 kHz.

Example 156. The computer-readable media of any one of the Examples herein, wherein the null signal is restricted to a frequency band that excludes frequencies below a lower threshold frequency, and wherein the lower threshold frequency is greater than about 200 Hz, 300 Hz, 400 Hz, 500 Hz, 600 Hz, 700 Hz, 800 Hz, 900 Hz, or 1 kHz.

Example 157. The computer-readable media of any one of the Examples herein, wherein the null signal is restricted to a frequency band that excludes frequencies above an upper threshold frequency, and wherein the upper threshold frequency less than about 1.0 kHz, 1.5 kHz, 2.0 kHz, 2.5 kHz, 3.0 kHz, 3.5 kHz, or 4.0 kHz.

Example 158. The computer-readable media of any one of the Examples herein, wherein the null signal comprises the vertical content signal being phase-shifted such that the null signal destructively interferes with the portion of the audio played back based on the vertical content along the first sound axis.

Example 159. The computer-readable media of any one of the Examples herein, wherein playing back the null signal via the forward-firing transducer is delayed with respect to playing back audio based on the vertical content signal via at least the up-firing transducer and the side-firing transducer or array.

1. A method comprising:
receiving, at a primary playback device, source audio data;
obtaining n channels of satellite audio data from the source audio data to be played back via a satellite playback device;
downmixing the n source channels of satellite audio data to m downmixed channels of audio satellite data according to a first downmixing scheme, wherein m<n, and wherein the first downmixing scheme is based at least in part on one or more first input parameters, wherein downmixing the n channels of satellite audio data to m channels of audio satellite data according to the first downmixing scheme comprises:
mapping a first channel of the n source channels to a first channel of the m downmixed channels:
mapping a first portion of a second channel of the n source channels to a first portion of a second channel of the m downmixed channels, and
mapping a second portion of a third channel of the n source channels to a second portion of the second channel of the m downmixed channels; and
wirelessly transmitting the downmixed m channels of audio data to the satellite playback device for playback.

2. The method of claim 1, further comprising:
after wirelessly transmitting the downmixed m channels of audio data to the satellite playback device for playback, receiving, at the primary playback device, one or more second input parameters different from the one or more first input parameters;
receiving, at the primary playback device, second source audio data;
downmixing the n channels of satellite audio data to m channels of audio satellite data according to a second downmixing scheme different from the first, wherein the second downmixing scheme is based at least in part on one or more second input parameters; and
wirelessly transmitting the downmixed m channels of audio data to the satellite playback device for playback.

3. The method of claim 1, further comprising:
after wirelessly transmitting the downmixed m channels of audio data to the satellite playback device for playback, receiving, at the primary playback device, second source audio data;
determining that network conditions are sufficient to transmit n channels of satellite audio data of the second source audio data to the satellite playback device; and
wirelessly transmitting the n channels of satellite audio data of the second source audio data to the satellite playback device.

4. The method of claim 1, wherein the one or more input parameters comprise one or more of: an audio content parameter, a device location parameter, a listener location parameter, a playback responsibilities parameter, or an environmental acoustics parameter.

5. (canceled)

6. (canceled)

7. The method of claim 1, further comprising playing back audio via the primary playback device in synchrony with playback of n upmixed n channels of audio data via the satellite playback device, wherein the n upmixed channels are upmixed at the satellite playback device.

8. (canceled)

9. (canceled)

10. The method of claim 1, wherein downmixing the n channels of satellite audio data to m channels of audio satellite data according to the first downmixing scheme comprises mapping a second portion of the second channel of the n source channels to the second portion of the second channel of the m downmixed channels such that the second portion of the second channel of the m downmixed channels comprises a combination of:
the second portion of the second channel of the n source channels; and
the second portion of the third channel of the n source channels.

11. The method of claim 1, further comprising downmixing the n source channels when wireless network conditions are insufficient to transmit the n source channels of satellite audio data to the satellite playback device.

12. (canceled)

13. (canceled)

14. -54. (canceled)

55. A playback device comprising:
at least one processor; and
memory having stored thereon instructions executable by the at least one processor to perform operations comprising:
receiving source audio data; obtaining n channels of satellite audio data from the source audio data to be played back via a satellite playback device;
downmixing the n source channels of satellite audio data to m downmixed channels of audio satellite data according to a first downmixing scheme, wherein m<n, and wherein the first downmixing scheme is based at least in part on one or more first input parameters, wherein downmixing the n channels of satellite audio data to m channels of audio satellite data according to the first downmixing scheme comprises:
mapping a first channel of the n source channels to a first channel of the m downmixed channels;
mapping a first portion of a second channel of the n source channels to a first portion of a second channel of the m downmixed channels; and
mapping a second portion of a third channel of the n source channels to a second portion of the second channel of the m downmixed channels; and
wirelessly transmitting the downmixed m channels of audio data to the satellite playback device for playback.

56. The playback device of claim 55, wherein the operations further comprise:
after wirelessly transmitting the downmixed m channels of audio data to the satellite playback device for playback, receiving one or more second input parameters different from the one or more first input parameters;
receiving second source audio data;
downmixing the n channels of satellite audio data to m channels of audio satellite data according to a second downmixing scheme different from the first, wherein the second downmixing scheme is based at least in part on one or more second input parameters; and
wirelessly transmitting the downmixed m channels of audio data to the satellite playback device for playback.

57. The playback device of claim 55, wherein the operations further comprise:
after wirelessly transmitting the downmixed m channels of audio data to the satellite playback device for playback, receiving second source audio data;
determining that network conditions are sufficient to transmit n channels of satellite audio data of the second source audio data to the satellite playback device; and
wirelessly transmitting the n channels of satellite audio data of the second source audio data to the satellite playback device.

58. The playback device of claim 55, wherein the one or more input parameters comprise one or more of: an audio content parameter, a device location parameter, a listener location parameter, a playback responsibilities parameter, or an environmental acoustics parameter.

59. The playback device of claim 55, wherein the operations further comprise playing back audio in synchrony with playback of n upmixed n channels of audio data via the satellite playback device, wherein the n upmixed channels are upmixed at the satellite playback device.

60. The playback device of claim 55, wherein downmixing the n channels of satellite audio data to m channels of audio satellite data according to the first downmixing scheme comprises mapping a second portion of the second channel of the n source channels to the second portion of the second channel of the m downmixed channels such that the second portion of the second channel of the m downmixed channels comprises a combination of:
the second portion of the second channel of the n source channels; and
the second portion of the third channel of the n source channels.

61. The playback device of claim 55, wherein the operations further comprise downmixing the n source channels when wireless network conditions are insufficient to transmit the n source channels of satellite audio data to the satellite playback device.

62. A non-transitory computer readable medium having stored thereon instructions executable by at least one processor to cause a playback device to perform operations comprising:
receiving source audio data; obtaining n channels of satellite audio data from the source audio data to be played back via a satellite playback device;
downmixing the n source channels of satellite audio data to m downmixed channels of audio satellite data according to a first downmixing scheme, wherein m<n, and wherein the first downmixing scheme is based at least in part on one or more first input parameters, wherein downmixing the n channels of satellite audio data to m channels of audio satellite data according to the first downmixing scheme comprises:
mapping a first channel of the n source channels to a first channel of the m downmixed channels;
mapping a first portion of a second channel of the n source channels to a first portion of a second channel of the m downmixed channels; and
mapping a second portion of a third channel of the n source channels to a second portion of the second channel of the m downmixed channels; and
wirelessly transmitting the downmixed m channels of audio data to the satellite playback device for playback.

63. The non-transitory computer readable medium of claim 62, wherein the operations further comprise:
after wirelessly transmitting the downmixed m channels of audio data to the satellite playback device for playback, receiving one or more second input parameters different from the one or more first input parameters;
receiving second source audio data;
downmixing the n channels of satellite audio data to m channels of audio satellite data according to a second downmixing scheme different from the first, wherein the second downmixing scheme is based at least in part on one or more second input parameters; and
wirelessly transmitting the downmixed m channels of audio data to the satellite playback device for playback.

64. The non-transitory computer readable medium of claim 62, wherein the operations further comprise:
after wirelessly transmitting the downmixed m channels of audio data to the satellite playback device for playback, receiving second source audio data;
determining that network conditions are sufficient to transmit n channels of satellite audio data of the second source audio data to the satellite playback device; and
wirelessly transmitting the n channels of satellite audio data of the second source audio data to the satellite playback device.

65. The non-transitory computer readable medium of claim 62, wherein the one or more input parameters comprise one or more of: an audio content parameter, a device location parameter, a listener location parameter, a playback responsibilities parameter, or an environmental acoustics parameter.

66. The non-transitory computer readable medium of claim 62, wherein the operations further comprise playing back audio in synchrony with playback of n upmixed n channels of audio data via the satellite playback device, wherein the n upmixed channels are upmixed at the satellite playback device.

67. The non-transitory computer readable medium of claim 62, wherein downmixing the n channels of satellite audio data to m channels of audio satellite data according to the first downmixing scheme comprises mapping a second portion of the second channel of the n source channels to the second portion of the second channel of the m downmixed channels such that the second portion of the second channel of the m downmixed channels comprises a combination of:
the second portion of the second channel of the n source channels; and
the second portion of the third channel of the n source channels.
